(19) United States
(12) Patent Application Publication
(10) Pub. No.: US 2026/0067196 A1
(43) Pub. Date: Mar. 5, 2026

(54) IN-SYSTEM TESTING ARCHITECTURE FOR AUTONOMOUS SYSTEMS AND APPLICATIONS

(71) Applicant: NVIDIA Corporation, Santa Clara, CA (US)

(72) Inventors: Abilash NERALLAPALLY, Newark, CA (US); Vishal AGARWAL, Santa Clara (CA); Shantanu SARANGI, Saratoga, CA (US); Milind SONAWANE, Santa Clara, CA (US); Nitin YOGI, Milpitas, CA (US); Anitha KALVA, San Jose, CA (US); Sailendra CHADALAVADA, Saratoga, CA (US)

(21) Appl. No.: 18/824,683

(22) Filed: Sep. 4, 2024

(51) Int. Cl. H04L 43/12

(52) U.S. Cl. CPC H04L 43/12

(57) ABSTRACT

Embodiments of the present disclosure relate to applications, platforms, architecture, etc. for using a master test image that may be used for multiple different tests. For example, a testing system may include a register bank that may be loaded with test configurations corresponding to one or more tests. The test configurations may respectively correspond to sets of control packets included in the master test image that may be used or executed for corresponding tests. The test configurations may indicate execution orders of their respective sets of control packets in which the execution order of one or more of the control packets included in the sets of control packets may differ from a default execution order of such control packets as indicated in the master test image. Such a configuration may accordingly allow for the flexibility of performing many different tests using a single master test image.

### BACKGROUND

Computing systems (e.g., systems on a chip (SoCs)) may undergo different tests with respect to different operations and functions of the computing systems. For example, In-System-Testing (IST) is a testing scheme that may be used to perform tests such as structural scans and/or memory tests related to computing systems. Further, IST may include performing tests on a full computing system (e.g., a full SoC, multiple SoCs, etc.) such as the full functionality of the computing system, all of the operations performed by the computing system, all of the components of the computing system (including hardware and/or software), etc. Additionally or alternatively, IST may include performing tests with respect to one or more subsets of the computing system including some of the functionality and/or operations that may be performed by the computing system and/or one or more subsets of the components of the computing system.

For example, in the context of vehicle systems, IST may be run either during Key-ON (e.g., when the vehicle is in a running or systems are in an “ON” state) only, Key-OFF (e.g., when the vehicle is in an “OFF” state) only, or during both Key-ON and OFF. It may be desirable to have flexibility to choose a shorter test during Key-ON (e.g., test only critical components in a corresponding SoC) vs a full test (e.g., test an entire SoC) during Key-OFF to keep the latency of testing within an acceptable window while trading off coverage.

With existing IST architecture (e.g., existing IST hardware (IST-HW)) and configurations, separate test images are generated for different tests to support the desired flexibility in testing. For example, test images may typically include control packets that may indicate which operations may be performed with respect to a particular test. Additionally, the control packets are typically included in the test images as a linked list in which the sequence of execution from one control packet to another is fixed and dictated by the linked list. Such a configuration accordingly typically requires that different test images be used for different tests. However, the logistics of generating, characterizing and productizing multiple test images is prohibitive. Further, this approach is difficult to scale as the test image requirements may vary depending on users.

### SUMMARY

Embodiments of the present disclosure relate to applications, platforms, architecture, etc. for using a master test image that may be used for multiple different tests. For example, a testing system may include a register bank that may be loaded with test configurations corresponding to different tests. The test configurations may respectively correspond to sets of control packets included in the master test image that may be used or executed for corresponding tests. The test configurations may indicate execution orders of their respective sets of control packets in which the execution order of one or more of the control packets included in the sets of control packets may differ from a default execution order of such control packets as indicated in the master test image. Such a configuration may accordingly allow for the flexibility of performing many different tests using a single master test image. Such flexibility allows for the ability to improve In-System-Testing (IST) by allowing for tailoring specific tests for specific needs without having to create individual test images for each of such tests. Such improvement of testing may also help improve the systems being tested by allowing for more flexibility in identifying ways in which such systems may be improved.

### BRIEF DESCRIPTION OF THE DRAWINGS

The present systems and methods for in-system testing for autonomous and semi-autonomous systems and applications are described in detail below with reference to the attached drawing figures, wherein:

FIG. 1A illustrates an example system configured to perform in-system testing, in accordance with one or more embodiments of the present disclosure;

FIG. 1B illustrates an example linked list of control packets that may be included in a test image, in accordance with one or more embodiments of the present disclosure;

FIG. 2 illustrates a flow diagram illustrating a method for performing in-system testing, in accordance with one or more embodiments of the present disclosure;

FIG. 3A is an illustration of an example autonomous vehicle, in accordance with one or more embodiments of the present disclosure;

FIG. 3B is an example of camera locations and fields of view for the example autonomous vehicle of FIG. 3A, in accordance with one or more embodiments of the present disclosure;

FIG. 3C is a block diagram of an example system architecture for the example autonomous vehicle of FIG. 3A, in accordance with one or more embodiments of the present disclosure;

FIG. 3D is a system diagram for communication between cloud-based server(s) and the example autonomous vehicle of FIG. 3A, in accordance with one or more embodiments of the present disclosure;

FIG. 4 is a block diagram of an example computing device suitable for use in implementing one or more embodiments of the present disclosure; and

FIG. 5 is a block diagram of an example data center suitable for use in implementing one or more embodiments of the present disclosure.

### DETAILED DESCRIPTION

Systems and methods disclosed herein may relate to in-system testing (IST) that may be used by machines. In general, IST may use test images for the execution of tests. The test images may include information related to instructions for execution of corresponding tests, stimuli or other information that may be used for the execution of the tests, and/or corresponding expected behavior of the computing system in response to the respective stimuli.

According to one or more embodiments of the present disclosure, system architectures and methods may be configured to provide for the use of a master test image for multiple different tests. By comparison, current IST architectures and techniques typically require specific and individual test images for each test that is desired to be performed.

The ability to use a master test image instead of having to use different test images for different tests may allow for more flexibility in testing by simplifying the elements that may be needed for multiple tests. Further, the use of a master test image that may take the place of multiple different test images may reduce the use of resources used for IST—e.g., the amount of memory used to store test images may be reduced.

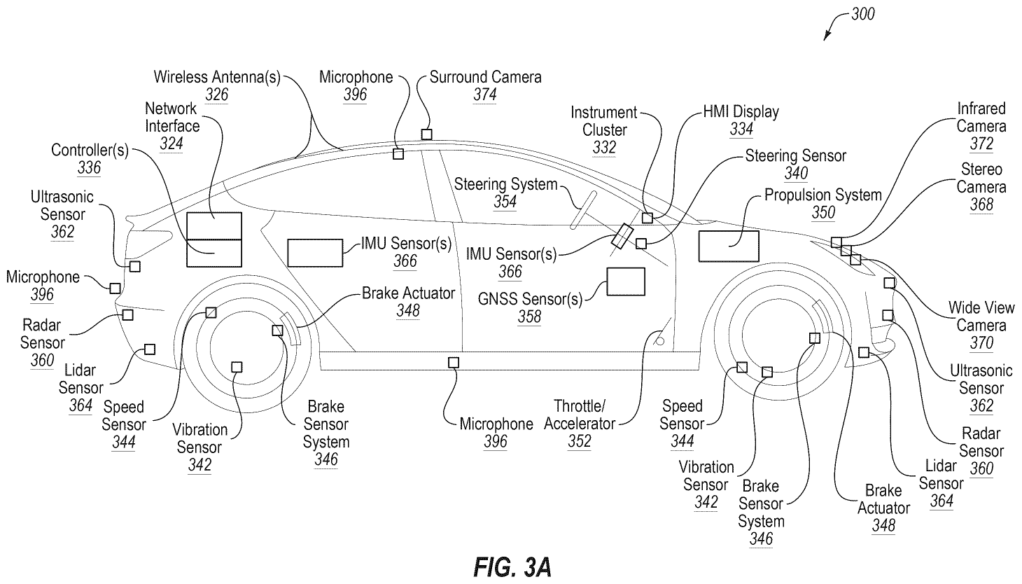

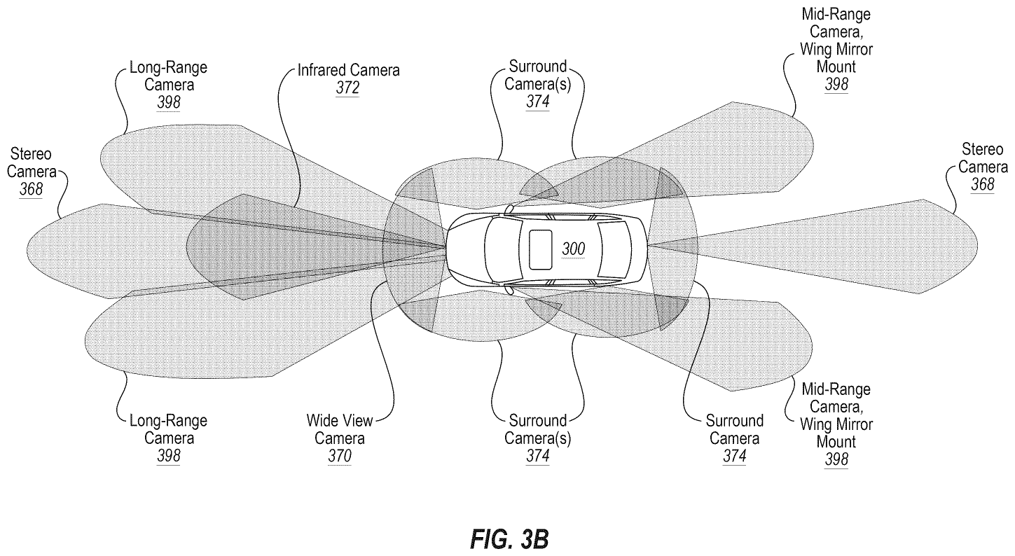

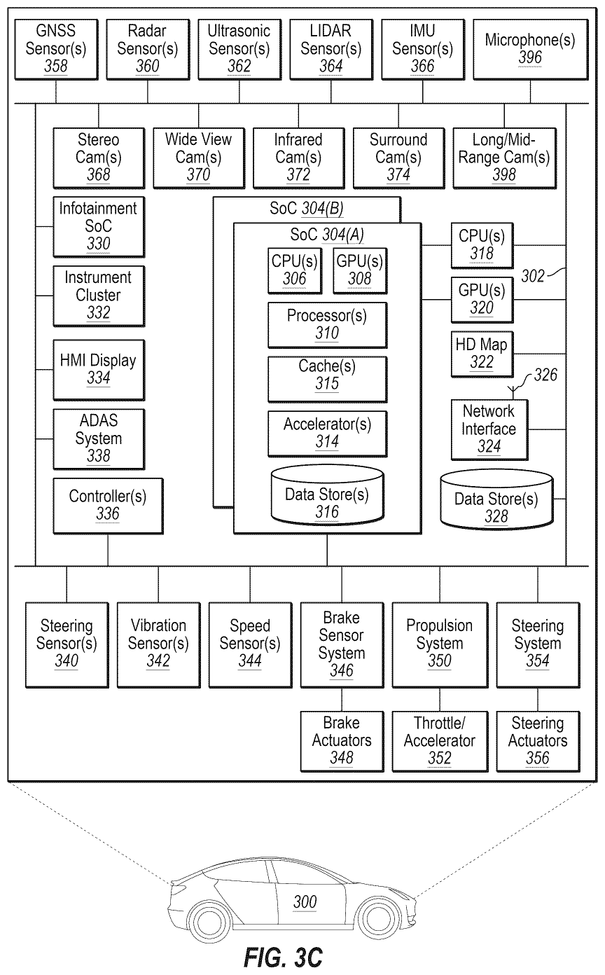

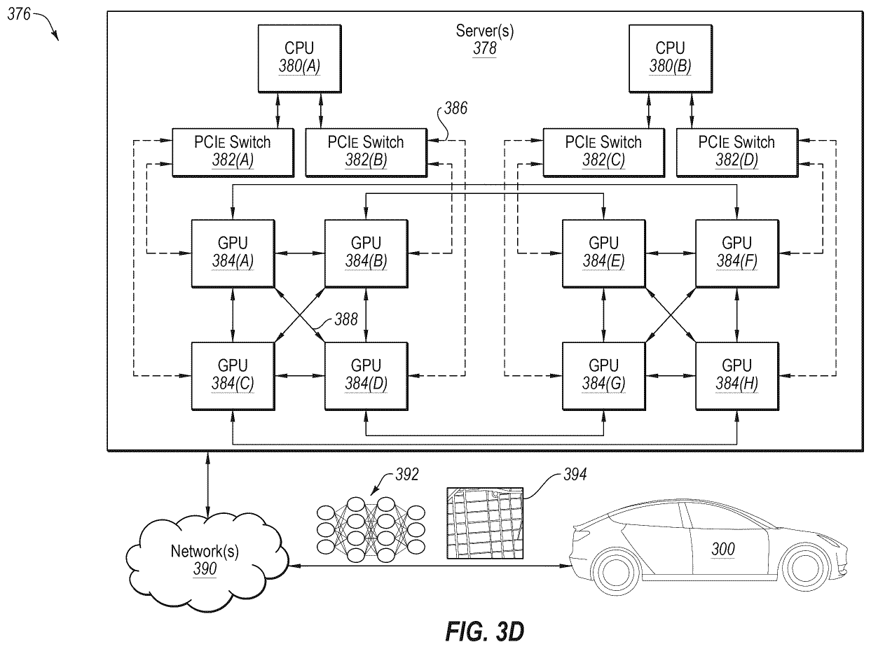

One or more embodiments of the present disclosure may relate to IST that may be associated with ego-machines and/or components of the one or more ego-machines, which may include any applicable machine or system that is capable of performing one or more autonomous or semi-autonomous operations. Example ego-machines may include, but are not limited to, vehicles (land, sea, space, and/or air), robots, robotic platforms, etc. By way of example, the ego-machine computing applications may include one or more applications that may be executed by an autonomous vehicle or semi-autonomous vehicle, such as an example autonomous vehicle 300 (alternatively referred to herein as “vehicle 300” or “ego-machine 300”) described with respect to FIGS. 3A-3D. In the present disclosure, reference to an “autonomous vehicle” or “semi-autonomous vehicle” may include any vehicle that may be configured to perform one or more autonomous or semi-autonomous navigation or driving operations. As such, such vehicles may also include vehicles in which an operator is required or in which an operator may perform such operations as well.

Additionally or alternatively, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, generative AI, data center processing, conversational AI (such as by employing one or more language models such as one or more large language models (LLMs)), light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations (e.g., systems that implement one or more LLMs), systems that implement one or more vision language models (VLMs), systems that implement one or more multi-modal language models, systems for performing one or more generative AI operations, systems for hosting real-time streaming applications, systems for presenting one or more of virtual reality content, augmented reality content, or mixed reality content, systems for performing light transport simulation, systems for performing collaborative content creation for 3D assets, systems implemented at least partially using cloud computing resources, and/or other types of systems.

The embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

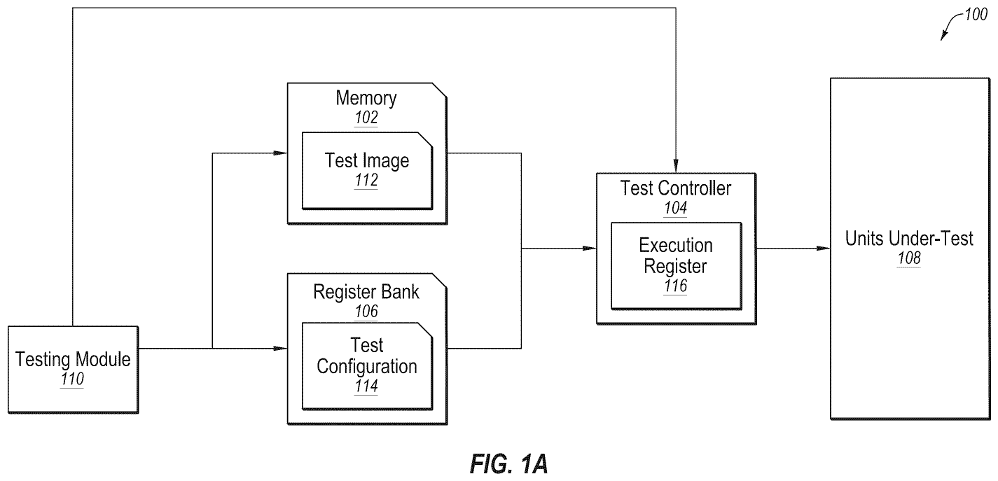

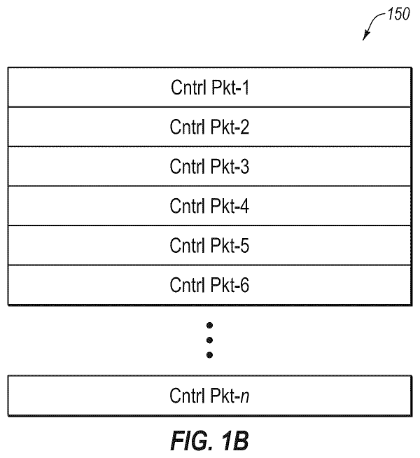

With respect to FIG. 1A, FIG. 1A illustrates an example system 100 configured to perform in-system testing, according to one or more embodiments of the present disclosure. In general, the system 100 may include a memory 102, a testing module 110, a test controller 104, a register bank 106, and one or more units under-test 108 (“test units 108”). It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out using hardware, firmware, and/or software. For instance, various functions may be carried out using a processor executing instructions stored in memory.

The test units 108 may include one or more elements of a computing system that may be tested using IST. For example, one or more of the test units 108 may individually include hardware and/or software components configured to perform one or more tasks or operations and/or configured to contribute to or facilitate the performance of one or more tasks or operations by the computing system.

For example, the test units 108 may include one or more of processing device(s), memory device(s), data storage device(s), communication device(s), software modules, etc., where an individual or collective of one or more test units 108 may be used in the performance of operations by the computing system. In some embodiments, the test units 108 may perform operations in various environments, which may include, but not be limited to, autonomous vehicles or machines, automotive or machine performance, and/or automotive or machine safety.

The memory 102 may include any suitable computer-readable storage media for carrying or having computer-executable instructions or data structures stored thereon. Such computer-readable storage media may include any available media that may be accessed by the controller 104. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store particular program code in the form of computer-executable instructions or data structures and which may be accessed by a general-purpose or special-purpose computer. Combinations of the above may also be included within the scope of computer-readable storage media.

Additionally or alternatively, in some embodiments the memory 102 may be part of or comprised of a multi-media card (MMC) that may include flash memory (e.g., NAND flash memory) and a corresponding storage controller. In these and other embodiments, the MMC may be configured as an embedded MMC (cMMC). Additionally or alternatively, the memory 102 may be off-chip memory in that the memory 102 may be separate from a chip that may include the testing module 110, the test controller 104, register bank 106, and/or the test units 108.

In some embodiments, the memory 102 may include stored thereon a master test image 112 (“image 112”). In general, the image 112 may include information that may be used to execute multiple tests and assess the results of such tests. Additionally or alternatively, the image 112 may be configured such that it may allow for multiple different types of tests to be performed. For example, in some embodiments, the image 112 may include information that may allow for execution of an embedded core test, a memory test, a scan test (also referred to as a “logic” test), or any other suitable test. In these and other embodiments, the tests may be implemented under various protocols or standards such as a via joint test action group (JTAG) based test or an IEEI 1500 standard based test.

In these and other embodiments, the image 112 may include control packets, data packets, and/or status packets that may correspond to performance of tests. The control packets may include instructions to decode and execute the test. Additionally or alternatively, the control packets may be ordered sequentially in the test image 112—for example as a linked list. In these and other embodiments, the sequential order of the control packets may indicate a default order of execution of the control packets during the execution of tests.

For example, FIG. 1B illustrates an example linked list 150 of “n” control packets that may be included in the image 112. In the illustrated example, the linked list 150 may indicate the default execution order of the control packets included therein. For example, the linked list 150 may indicate that the default execution order is such that a first control packet (cntrl pkt-1) is to be executed first, followed by a second control packet (cntrl pkt-2), then a third control packet (cntrl pkt-3), etc. until the nth control packet (cntrl pkt-n) has been executed.

The data packets may include inputs and/or stimuli that may be used in the execution of tests. For example, in some embodiments, one or more data packets may include test vectors (e.g., scan test vectors) and the data for programming registers to control the Clocks, Resets, Dynamic Function exchange (DFX) Controls, and/or Pad Controls corresponding to the test units 108.

The results packets may include the behavior of the test units 108 during the test as performed based on the control packets and/or the data packets. For example, in some embodiments, the results packets include a Scan Test response or a Memory Test response.

In these and other embodiments, the status packets may include a summary of the corresponding test execution. For example, in some embodiments, one or more status packets may indicate whether the test units 108 passed or failed a test, errors that may have been identified from a test, etc.

The register bank 106 may include any suitable memory that may be accessed by the controller 104. For example, in some embodiments, the register bank 106 may be part of a memory that is separate from the controller 104. Additionally or alternatively, the register bank 106 may be a set of registers that are included with the controller 104. Further, although the term “register” is used, it is understood that any suitable memory that may be used in the manner in which the register bank 106 is described in the present disclosure is included in the scope of the present disclosure.

In some embodiments, the register bank 106 may be loaded with one or more test configurations 114. The test configurations 114 may individually correspond to different tests that may be performed with respect to one or more of the test units 108. In some embodiments, an individual test configuration 114 may correspond to a single test. Additionally or alternatively, an individual test configuration 114 may correspond to part of a particular test. In these and other embodiments, an individual test configuration 114 may correspond to multiple tests.

In some embodiments, the test configurations 114 may respectively correspond to sets of one or more control packets included in the image 112 that may be used or executed with respect to tests respectively corresponding to the test configurations 114. An individual test configuration 114 may indicate an execution order of a particular set of control packets in which the execution order of the control packets included in the set of control packets differs from the default execution order of such control packets as indicated in the image 112.

The differing in the execution orders indicated by the test configurations 114 may include one or more differences in the default execution order indicated by the image 112. In general, in the present disclosure any deviation from execution of all of the control packets in the image 112 according to the default execution order may be considered a “difference” in the default execution order. For instance, an example execution order difference may include executing only a subset of control packets included in the image 112 even in instances in which the subset of control packets that is executed is executed in the default execution order. Another example execution order difference may include repeating execution of a particular control packet in a row or at a later time. In these and other embodiments, an example execution order difference may include skipping execution of control packets as compared to the default execution order, and/or jumping back to execution of a control packet included earlier in the default execution order after executing a control packet that is later in the default execution order, etc.

Note that in some embodiments, and as discussed in further detail in the present disclosure, the tests to which the test configurations 114 correspond may include the execution of more control packets than those included in the sets of control packets included in the test configurations 114. In these and other embodiments, the control packets that are part of such tests and that are not included in the corresponding set of control packets may be executed according to the default execution order indicated in the image 112.

In these and other embodiments, the register bank 106 may include information corresponding to the individual test configurations 114 loaded thereon. The information may indicate the execution orders of control packets for the tests for which the test configurations 114 correspond. For example, individual registers of the register bank 106 may respectively include a first field and a second field respectively populated with values to indicate individual execution orders of one or more control packets corresponding to individual tests. Additionally or alternatively, the number of registers with populated fields may vary depending on the number of variations from the default execution order of the tests.

In some instances, the first field may be populated with a first entry indicating a deviation point during a test execution that may indicate a point at which the default execution order may subsequently be deviated from. For example, the first field may include a first particular control packet of the image 112. The inclusion of the first particular control packet in the first entry may be an indication that a deviation from the default execution order may occur after execution of the first particular control packet. Additionally or alternatively, the first field may include an “initialization” or “begin” indication that may indicate that that a deviation from the default execution order may occur immediately upon beginning to execute a corresponding test.

Additionally or alternatively, the second field may be populated with a second entry indicating a next step that is to be performed at the deviation point indicated by the corresponding first entry. For example, in some instances, the second field may include a second particular control packet of the image 112. The inclusion of the second particular control packet in the second entry may indicate that the second particular control packet is to be executed at the deviation point corresponding to the first field (e.g., after the first particular control packet in instances in which the first particular control packet may be the first value included in the first field). In these and other embodiments, the second field may include a “terminate” or “stop” indication that may indicate that that the corresponding test is to be terminated at the deviation point.

For example, with reference to the linked list 150 of FIG. 1B as an example, a particular test configuration 114 corresponding to a particular test may be loaded into the register bank 106. In these and other embodiments, the particular test may be such that the first control packet (Cntrl Pkt-1) is to be executed first, followed by execution of the second control packet (Cntrl Pkt-2), followed by execution of the fourth control packet (Cntrl Pkt-4) two times in a row, followed by execution of the seventh control packet (Cntrl Pkt-7), followed by execution of the third control packet (Cntrl Pkt-3), and then termination of the particular test. To illustrate this, the particular test may be indicated in expression (1) below as follows:

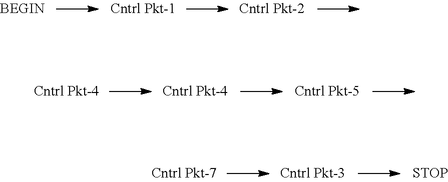

As such, the particular test may differ from the default execution order of the image 112 in a variety of ways such as jumping from the second control packet to the fourth control packet, executing the fourth control packet two times in a row, jumping from execution of the fifth control packet to the seventh control packet, jumping from the seventh control packet back to the third control packet, and terminating the particular test after executing the third control packet without executing all of the control packets included in the image 112.

In some embodiments, registers of the register bank 106 may be loaded as indicated in Table 1 below to reflect the particular test configuration 114 corresponding to the particular test indicated by expression (1).

TABLE 1

| Register | First Field | Second Field |
|---|---|---|
| Register-1 | Cntrl Pkt-2 | Cntrl Pkt -4 |
| Register-2 | Cntrl Pkt -4 | Cntrl Pkt -4 |
| Register-3 | Cntrl Pkt -5 | Cntrl Pkt -7 |
| Register-4 | Cntrl Pkt -7 | Cntrl Pkt -3 |
| Register-5 | Cntrl Pkt -3 | STOP |

As described above, the first deviation point of the particular test from the default execution order indicated by the image 112 may occur after execution of the second control packet (Cntrl Pkt-2). Further, the deviation from the default execution order may be jumping to execution of the fourth control packet (Cntrl Pkt-4) after execution of the second control packet.

As indicated by Table 1, a first register (Register 1) of the register bank 106 may be populated with entries to reflect the change in execution order. For example, the first register may include a first field with a first entry indicating the second control packet to indicate that the first deviation point occurs after execution of the second control packet. Additionally or alternatively, the first register may also include a second field with second entry indicating the fourth control packet. The second entry may indicate that the particular test is to jump to execution of the fourth control packet. Therefore, the first and second entries in the first and second fields, respectively, of the first register may indicate that the fourth control packet is to be executed after execution of the second control packet, which differs from the example default execution order of the image 112 illustrated in FIG. 1B. Registers two through five include entries in the same manner to indicate the other deviation points and corresponding types of deviations that are part of the particular test indicated by expression 1.

The register bank 106 may include more registers than those illustrated in Table 1. Table 1 is merely meant to illustrate an example of registers that may be loaded with respect to the particular test.

The controller 104 may be communicatively coupled to the register bank 106 and to the memory 102. In general, the controller 104 may be configured to execute tests with respect to one or more of the test units 108 based on the image 112 and based on corresponding test configurations 114 that have been loaded into the register bank 106.

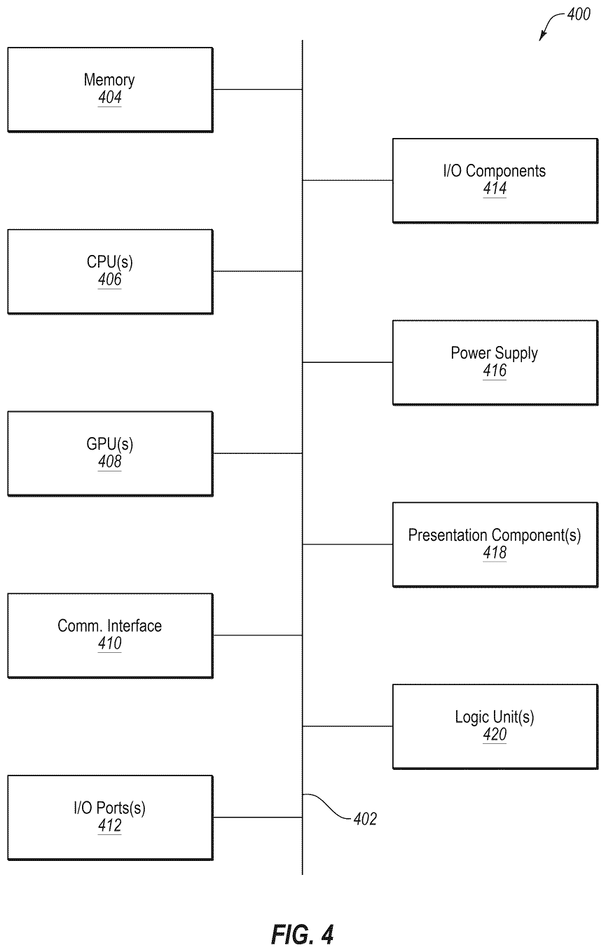

In some embodiments, the controller 104 may include code and routines configured to cause performance of the operations described with respect to the controller 104. Additionally or alternatively, the controller 104 may be implemented using hardware including one or more processors, CPUs graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs)), one or more programmable vision accelerators (PVAs), which may include one or more vector processing units (VPUs), one or more direct memory access (DMA) systems, one or more pixel processing engines (PPEs), etc., and/or other processor types. In these and other embodiments, the controller 104 may be implemented using a combination of hardware and software. In the present disclosure, operations described as being performed by the controller 104 may include operations that the controller 104 may direct a corresponding computing system to perform. In these or other embodiments, the controller 104 may be implemented by one or more computing devices, such as that described in further detail with respect to FIGS. 3A-4D, 4, and/or 5.

In some embodiments, the controller 104 may be configured to execute control packets for tests by following the default order included in the image 112 unless indicated otherwise by entries in the register bank 106 that correspond to the respective test configurations 114 of the respective tests.

For example, referring to the particular test of expression (1) and Table 1, in some embodiments upon initialization of the particular test, the controller 104 may load the information from Register 1 of the register bank 106 into an execution register 116. The execution register 116 may include any memory that may be used to temporarily store information that may be referenced by the controller 104 as part of current testing operations that are being performed by the controller 104. In some embodiments, the execution register 116 may be separate from the register bank 106. Additionally or alternatively, the execution register 116 may be part of the register bank 106. In these or other embodiments, the Register 1 may be used as the execution register 116 such that the loading of the execution register 116 from Register 1 may occur when Register 1 is loaded.

Additionally or alternatively, the entries of the registers in the register bank 106 may move up one register following the loading of the execution register 116. Table 2 illustrates an example of the register entries of the register bank 106 and the execution register 116 after the loading of the execution register 116 upon initialization of the particular test in which the entries have shifted up one register as compared to Table 1. The example of Table 2 is with respect to an embodiment in which the execution register 116 is separate from Register 1. However, it is understood that such specific implementation details are used to illustrate general principles described herein and are not meant to be limiting. Further, note that Register 5 is not illustrated in Table 2. In some instances, following the loading of the execution register 116, Register 5 may now have no entries. Additionally or alternatively, in some instances, Register 5 may be loaded with other indications related to another test configuration corresponding to another test.

TABLE 2

| Register | First Field | Second Field |
|---|---|---|
| Execution Register | Cntrl Pkt-2 | Cntrl Pkt -4 |
| Register-1 | Cntrl Pkt -4 | Cntrl Pkt -4 |
| Register-2 | Cntrl Pkt -5 | Cntrl Pkt -7 |
| Register-3 | Cntrl Pkt -7 | Cntrl Pkt -3 |
| Register-4 | Cntrl Pkt -3 | STOP |

The controller 104 may use the information in the execution register 116 to determine how to proceed with respect to the particular test. For instance, the default execution order indicates that the first control packet is to be executed first. The controller 104 may first check the first entry of the first field of the execution register 116 to determine whether a deviation point occurs upon beginning execution of the particular test. For example, the controller 104 may determine whether a control packet other than the first control packet is to be executed first based on whether the first field includes an “initialization” or “begin” entry indicating that the first deviation point is upon initialization. In the illustrated example, the first field of the execution register 116 indicates a deviation point after execution of the second control packet and not upon initialization of the particular test such that the controller 104 may begin the particular test by executing the first control packet as indicated in the default execution order.

After the first stage (e.g., after execution of the first control packet) and before executing the second stage of the particular test, the controller 104 may again check the execution register 116 to determine whether a deviation from the default execution order is to occur after execution of the first control packet. In the illustrated example of Table 2, the first entry in the first field of the execution register 116 may still indicate that the deviation point is after execution of the second control packet and not after execution of the first control packet. As such, the controller 104 may be configured to execute the second stage of the particular test by executing the second control packet as indicated by the default execution order.

After the second stage (e.g., after execution of the second control packet) and before executing the third stage of the particular test, the controller 104 may again check the execution register 116 to determine whether a deviation from the default execution order is to occur after execution of the second control packet. As explained previously, in the illustrated example of Table 2, the first entry in the first field of the execution register 116 may still indicate that the deviation point is after execution of the second control packet. As such, because the second control packet just finished executing and based on the first field of the execution register 116 indicating the second control packet, the controller 104 may be configured to identify that the next control packet to be executed may be different from the default execution order. In these and other embodiments, the controller 104 may read the second entry of the second field of the execution register 116 to determine which control packet to execute next. In the illustrated example, the controller 104 may execute the third stage of the particular test by executing the fourth control packet as the fourth control packet is indicated in the second field of the execution register 116.

In these and other embodiments, at some point prior to execution of the third stage finishing, the entries of the execution register 116 may be updated with the entries of Register 1 of the register bank 106 and the other entries of the register bank may shift and move up registers. Table 3 illustrates an example of the register entries of the register bank 106 and the execution register 116 after the updating of the execution register 116 with respect to the third execution stage. Further, note that Register 4 is illustrated in Table 3 as being blank due to the shift in register entries. Additionally or alternatively, in some instances, Register 4 may be loaded with other indications related to another test configuration corresponding to another test.

TABLE 3

| Register | First Field | Second Field |
|---|---|---|
| Execution Register | Cntrl Pkt -4 | Cntrl Pkt -4 |
| Register-1 | Cntrl Pkt -5 | Cntrl Pkt -7 |
| Register-2 | Cntrl Pkt -7 | Cntrl Pkt -3 |
| Register-3 | Cntrl Pkt -3 | STOP |
| Register-4 | | |

After the third stage (e.g., after execution of the fourth control packet) and before executing the fourth stage of the particular test, the controller 104 may again check the execution register 116 to determine whether a deviation from the default execution order is to occur after execution of the fourth control packet. In the illustrated example of Table 3, the first entry in the first field of the execution register 116 may indicate that a deviation point occurs after execution of the fourth control packet. As such, because the fourth control packet just finished executing and based on the first field of the execution register 116 indicating the fourth control packet, the controller 104 may be configured to identify that the next control packet to be executed may be the fourth control packet again based on the indication of the fourth control packet in the second field of the execution register 116. In the illustrated example, the controller 104 may accordingly execute the fourth stage of the particular test by repeating executing the fourth control packet.

In these and other embodiments, at some point prior to execution of the fourth stage finishing, the entries of the execution register 116 may be updated with the entries of Register 1 of the register bank 106 and the other entries of the register bank may shift and move up registers. Table 4 illustrates an example of the register entries of the register bank 106 and the execution register 116 after the updating of the execution register 116 with respect to the fourth execution stage. Further, note that Registers 3 and 4 are illustrated in Table 4 as being blank due to the shift in register entries. Additionally or alternatively, in some instances, one or more of Registers 3 or 4 may be loaded with other indications related to another test configuration corresponding to another test.

TABLE 4

| Register | First Field | Second Field |
|---|---|---|
| Execution Register | Cntrl Pkt -5 | Cntrl Pkt -7 |
| Register-1 | Cntrl Pkt -7 | Cntrl Pkt -3 |
| Register-2 | Cntrl Pkt -3 | STOP |
| Register-3 | | |
| Register-4 | | |

After the fourth stage (e.g., after execution of the fourth control packet the second time) and before executing the fifth stage of the particular test, the controller 104 may again check the execution register 116 to determine whether a deviation from the default execution order is to occur after execution of the fourth control packet. In the illustrated example of Table 4, the first entry in the first field of the execution register 116 may indicate that a deviation point occurs after execution of the fifth control packet. As such, because the fourth control packet just finished executing, the controller 104 may revert back to the default execution order indicated in the linked list 150 of the image 112. The default execution order may indicate that the fifth control packet is to be executed after the fourth control packet. In the illustrated example, the controller 104 may accordingly execute the fifth stage of the particular test by executing the fifth control packet.

After the fifth stage (e.g., after execution of the fifth control packet) and before executing the sixth stage of the particular test, the controller 104 may again check the execution register 116 to determine whether a deviation from the default execution order is to occur after execution of the fifth control packet. In the illustrated example of Table 4, the first entry in the first field of the execution register 116 may indicate that a deviation point occurs after execution of the fifth control packet. As such, because the fifth control packet just finished executing, the controller 104 may refer to the second entry in the second field of the execution register 116. The controller 104 may accordingly determine that the next control packet to execute may be the seventh control packet. In the illustrated example, the controller 104 may accordingly execute the sixth stage of the particular test by executing the seventh control packet.

In these and other embodiments, at some point prior to execution of the sixth stage finishing, the entries of the execution register 116 may be updated with the entries of Register 1 of the register bank 106 and the other entries of the register bank may shift and move up registers. Table 5 illustrates an example of the register entries of the register bank 106 and the execution register 116 after the updating of the execution register 116 with respect to the sixth execution stage. In the illustrated example of Table 5, Registers, 2, 3 and 4 are blank due to the shift in register entries. Additionally or alternatively, in some instances, one or more of Registers 2, 3, or 4 may be loaded with other indications related to another test configuration corresponding to another test.

TABLE 5

| Register | First Field | Second Field |
|---|---|---|
| Execution Register | Cntrl Pkt -7 | Cntrl Pkt -3 |
| Register-1 | Cntrl Pkt -3 | STOP |
| Register-2 | | |
| Register-3 | | |
| Register-4 | | |

After the sixth stage (e.g., after execution of the seventh control packet) and before executing the seventh stage of the particular test, the controller 104 may again check the execution register 116 to determine whether a deviation from the default execution order is to occur after execution of the seventh control packet. In the illustrated example of Table 5, the first entry in the first field of the execution register 116 may indicate that a deviation point occurs after execution of the seventh control packet. As such, because the seventh control packet just finished executing, the controller 104 may refer to the second entry in the second field of the execution register 116. The controller 104 may accordingly determine that the next control packet to execute may be the third control packet. In the illustrated example, the controller 104 may accordingly execute the seventh stage of the particular test by executing the third control packet.

In these and other embodiments, at some point prior to execution of the seventh stage finishing, the entries of the execution register 116 may be updated with the entries of Register 1 of the register bank 106 and the other entries of the register bank may shift and move up registers. Table 6 illustrates an example of the register entries of the register bank 106 and the execution register 116 after the updating of the execution register 116 with respect to the seventh execution stage. In the illustrated example of Table 6, Registers, 1, 2, 3, and 4 of the register bank 106 are blank due to the shift in register entries. Additionally or alternatively, in some instances, one or more of Registers 1, 2, 3, or 4 may be loaded with other indications related to another test configuration corresponding to another test.

TABLE 6

| Register | First Field | Second Field |
|---|---|---|
| Execution Register | Cntrl Pkt -3 | STOP |
| Register-1 | | |
| Register-2 | | |
| Register-3 | | |
| Register-4 | | |

After the seventh stage (e.g., after execution of the third control packet) and before executing the seventh stage of the particular test, the controller 104 may again check the execution register 116 to determine whether a deviation from the default execution order is to occur after execution of the seventh control packet. In the illustrated example of Table 6, the first entry in the first field of the execution register 116 may indicate that a deviation point occurs after execution of the third control packet. As such, because the third control packet just finished executing, the controller 104 may refer to the second entry in the second field of the execution register 116. The controller 104 may accordingly determine that the test is to stop due to the “STOP” indication included in the second field. In the illustrated example, the controller 104 may not execute any more control packets and may accordingly end the particular test.

The testing module 110 may include code and routines configured to cause performance of one or more testing related operations by the controller 104 as described herein. Additionally or alternatively, the testing module 110 may be implemented using hardware including one or more processors, CPUs graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs)), one or more programmable vision accelerators (PVAs), which may include one or more vector processing units (VPUs), one or more direct memory access (DMA) systems, one or more pixel processing engines (PPEs), etc., and/or other processor types. In these and other embodiments, the testing module 110 may be implemented using a combination of hardware and software. In the present disclosure, operations described as being performed by the testing module 110 may include operations that the testing module 110 may direct a corresponding computing system to perform. In these or other embodiments, the testing module 110 may be implemented by one or more computing devices, such as that described in further detail with respect to FIGS. 3A-4D, 4, and/or 5.

In general, the testing module 110 may be configured to direct the administration of tests of one or more of the test units 108 by the controller 104. For example, the testing module 110 may be configured to load the register bank 106 with certain test configurations 114. In these and other embodiments, the testing module 110 may be configured to receive the test configurations 114 as input. Additionally or alternatively, the testing module 110 may be configured to generate one or more of the test configurations 114 based on received input (e.g., received user input regarding certain parameters to be tested for a particular test and/or regarding which control packets are to be executed and in which order they are to be executed for respective tests.

In these and other embodiments, the testing module 110 may be configured to direct the controller 104 as to when to begin executing tests. Additionally or alternatively, the memory 102 may include multiple different test images 112 stored thereon. In these and other embodiments, the testing module 110 may indicate which test image 112 the controller may draw from for particular tests.

Modifications, additions, or omissions may be made to FIGS. 1A and 1B and the associated descriptions without departing from the scope of the present disclosure. For example, in some embodiments, the system 100 may include any number of units under test. Alternatively, or additionally, some embodiments may include implementations different from those described. For example, in some embodiments, the entries of first fields of the registers may indicate whether the deviation point occurs prior to the control packet indicated in the particular entries rather than after as described. Alternatively, or additionally, in some embodiments, the system 100 may include any number of other components, actions, or inputs that may not be explicitly illustrated or described. Moreover, although the above description focuses mainly on the execution of control packets with respect to performance of tests, many other operations may be performed with respect to such tests (e.g., as dictated by the control packets) that are not described herein.

In addition, although the description and explicit examples relate to loading a single test configuration 114 in the register bank 106, in some instances multiple test configurations 114 may be loaded in the register bank 106 at the same time. Additionally or alternatively, different test configurations 114 may be loaded in the register bank 106 in sequential order.

Further, in some instances the register bank 106 may not be large enough to indicate all the different deviations from the default execution order associated with a particular test. In some embodiments, multiple test configurations 114 or sub-test configurations of a larger test configuration 114 corresponding to the same test may be generated and loaded in the register bank 106 in a sequential manner. In these and other embodiments, the next test configuration 114 (or next sub-test configuration) after the current test configuration 114 (or current sub-test configuration) currently being used may be loaded in a piecewise manner as registers of the register bank 106 become available. Additionally or alternatively, the next test configuration 114 (or next sub-test configuration) may be loaded in the register bank 106 after the register bank 106 has been cleared of all entries corresponding to the previous test configuration 114 (or previous sub-test configuration).

Further, the number of control packets executed during tests or which control packets may be executed during tests may vary. For example, in some instances all of the control packets included in the image 112 may be executed during a particular test. Additionally or alternatively, in some instances only a subset of control packets included in the image 112 may be executed during a particular test.

In these and other embodiments, the control packets that may be included in the sets of control packets corresponding to different test configurations may vary. For example, in some instances, a particular set of control packets corresponding to a particular test configuration 114 may include all the control packets executed during a particular test (e.g., in instances in which none of the control packets are executed according to the default execution order). Additionally or alternatively, a particular set of control packets corresponding to a particular test configuration 114 may include a subset of the control packets executed during a particular test (e.g., in instances in which at least some of the control packets are executed according to the default execution order).

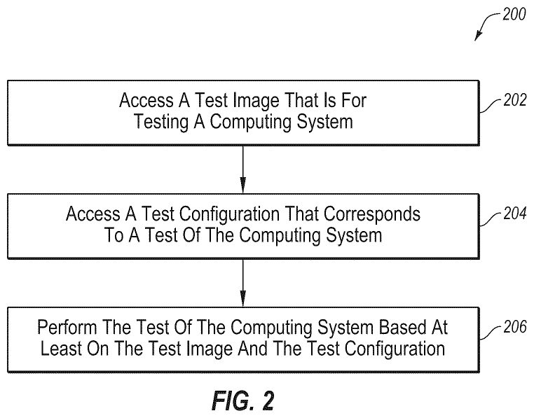

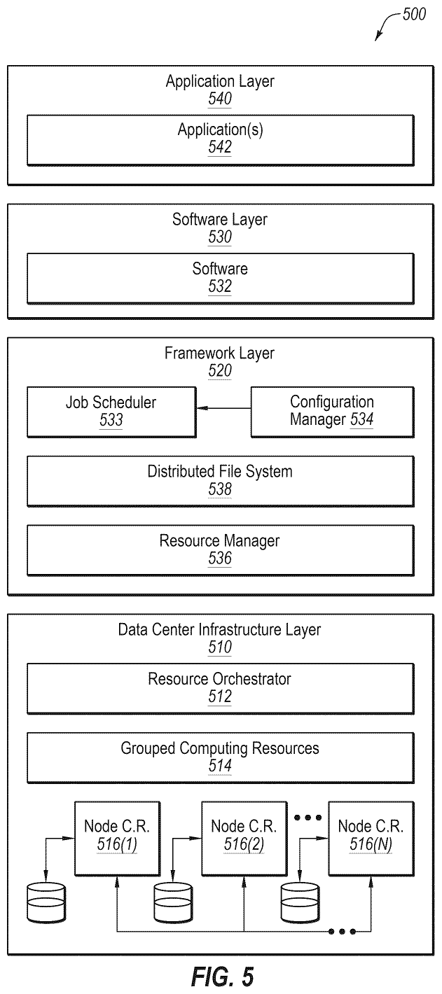

FIG. 2 is a flow diagram illustrating a method 200 for performing in-system-testing, in accordance with one or more embodiments of the present disclosure. One or more operations of the method 200 may be performed by any suitable system, apparatus, or device such as, for example, one or more components of the system 100 of FIG. 1 (e.g., the test controller 104), the autonomous vehicle system(s) described with respect to FIGS. 3A-3D, computing device(s) described with respect to FIG. 4, and/or the data system(s) described with respect to FIG. 5 in the present disclosure.

The method 200 may include a block B202 where a test image that may be used for testing a computing system may be accessed. In some embodiments, the test image may indicate a default execution order for execution of control packets that are used to perform a test of the computing system. For example, the default execution order may be based at least on a sequential ordering of the control packets as indicated by a linked list of the control packets as included in the test image—e.g., such as indicated in FIG. 1B of the present disclosure. The test image 112 described with respect to FIGS. 1A and 1B may be an example of the test image that may be accessed. In some embodiments, a test controller (e.g., the test controller 104 of FIG. 1A) may access the test image.

Additionally or alternatively, in some embodiments, the test image may be stored on and accessed from a memory that is remote from the test controller (e.g., disposed on a chip separate from that which may include the test controller). In these and other embodiments, the test image may be stored on and accessed from a memory that is local to the test controller (e.g., disposed on the same chip that includes the test controller).

At block B204, a test configuration that corresponds to the test of the computing system may be accessed. The test configuration may correspond to a set of control packets of the control packets included in the test image. In some embodiments, the set of control packets may include all of the control packets included in the test image. Additionally or alternatively, the set of control packets may include only a subset of all of the control packets included in the test image. The test configuration may indicate an execution of the set of control packets in an execution order that differs from the default execution order. For example, the test configuration 114 described with respect to FIGS. 1A and 1B may be an example of the test configuration.

In some embodiments, the test configuration may be accessed from a memory that the same as the memory from which the test image may be accessed. Additionally or alternatively, in some embodiments, the test configuration may be accessed from a memory that is different from the memory from which the test image may be accessed. For example, in some embodiments, the test configuration may be stored on and accessed from a register bank, such as the register bank 106 described with respect to FIGS. 1A and 1B. In these and other embodiments, the register bank may be an internal register bank of the test controller. Additionally or alternatively, the register bank may be external from the test controller.

At block B206, the test of the computing system may be performed based at least on the test image and the test configuration. In some embodiments, the test may be performed such as the test performance described in the present disclosure with respect to FIGS. 1A and 1B as well as Tables 1-6. As such, the method 200 may be used to perform one or more IST's according to one or more embodiments of the present disclosure.

Modifications, additions, or omissions may be made to the method 200 without departing from the scope of the present disclosure. For example, although illustrated as discrete blocks, various blocks of the method 200 may be divided into additional blocks, combined into fewer blocks, or eliminated, depending on the particular implementations.

Further, in some embodiments the method 200 may be used to perform multiple different tests based on the same test image and multiple different test configurations. For example, in some embodiments a first test may be performed with respect to the computing system based on the test image and a first test configuration. Additionally or alternatively, a second test may be performed with respect to the computing system based on the test image and a second test configuration.

### Example Autonomous Vehicle

FIG. 3A is an illustration of an example autonomous vehicle 300, in accordance with some embodiments of the present disclosure. The autonomous vehicle 300 (alternatively referred to herein as the “vehicle 300”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a drone, and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 300 may be capable of functionality in accordance with one or more of Level 3-Level 5 of the autonomous driving levels. The vehicle 300 may be capable of functionality in accordance with one or more of Level 1-Level 5 of the autonomous driving levels. For example, the vehicle 300 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 300 or other machine, such as being fully autonomous, being highly autonomous, being conditionally autonomous, being partially autonomous, providing assistive autonomy, being semi-autonomous, being primarily autonomous, or other designation.

The vehicle 300 may include components such as a chassis, a vehicle body, wheels (e.g., 2, 4, 6, 8, 18, etc.), tires, axles, and other components of a vehicle. The vehicle 300 may include a propulsion system 350, such as an internal combustion engine, hybrid electric power plant, an all-electric engine, and/or another propulsion system type. The propulsion system 350 may be connected to a drive train of the vehicle 300, which may include a transmission, to enable the propulsion of the vehicle 300. The propulsion system 350 may be controlled in response to receiving signals from the throttle/accelerator 352.

A steering system 354, which may include a steering wheel, may be used to steer the vehicle 300 (e.g., along a desired path or route) when the propulsion system 350 is operating (e.g., when the vehicle is in motion). The steering system 354 may receive signals from a steering actuator 356. The steering wheel may be optional for full automation (Level 5) functionality.

The brake sensor system 346 may be used to operate the vehicle brakes in response to receiving signals from the brake actuators 348 and/or brake sensors.

Controller(s) 336, which may include one or more CPU(s), system on chips (SoCs) 304 (FIG. 3C) and/or GPU(s), may provide signals (e.g., representative of commands) to one or more components and/or systems of the vehicle 300. For example, the controller(s) may send signals to operate the vehicle brakes via one or more brake actuators 348, to operate the steering system 354 via one or more steering actuators 356, and/or to operate the propulsion system 350 via one or more throttle/accelerators 352. The controller(s) 336 may include one or more onboard (e.g., integrated) computing devices (e.g., supercomputers) that process sensor signals, and output operation commands (e.g., signals representing commands) to enable autonomous driving and/or to assist a human driver in driving the vehicle 300. The controller(s) 336 may include a first controller 336 for autonomous driving functions, a second controller 336 for functional safety functions, a third controller 336 for artificial intelligence functionality (e.g., computer vision), a fourth controller 336 for infotainment functionality, a fifth controller 336 for redundancy in emergency conditions, and/or other controllers. In some examples, a single controller 336 may handle two or more of the above functionalities, two or more controllers 336 may handle a single functionality, and/or any combination thereof.

The controller(s) 336 may provide the signals for controlling one or more components and/or systems of the vehicle 300 in response to sensor data received from one or more sensors (e.g., sensor inputs). The sensor data may be received from, for example and without limitation, global navigation satellite systems sensor(s) 358 (e.g., Global Positioning System sensor(s)), RADAR sensor(s) 360, ultrasonic sensor(s) 362, LIDAR sensor(s) 364, inertial measurement unit (IMU) sensor(s) 366 (e.g., accelerometer(s), gyroscope(s), magnetic compass(es), magnetometer(s), etc.), microphone(s) 396, stereo camera(s) 368, wide-view camera(s) 370 (e.g., fisheye cameras), infrared camera(s) 372, surround camera(s) 374 (e.g., 360 degree cameras), long-range and/or mid-range camera(s) 398, speed sensor(s) 344 (e.g., for measuring the speed of the vehicle 300), vibration sensor(s) 342, steering sensor(s) 340, brake sensor(s) 346 (e.g., as part of the brake sensor system 346), and/or other sensor types.

One or more of the controller(s) 336 may receive inputs (e.g., represented by input data) from an instrument cluster 332 of the vehicle 300 and provide outputs (e.g., represented by output data, display data, etc.) via a human-machine interface (HMI) display 334, an audible annunciator, a loudspeaker, and/or via other components of the vehicle 300. The outputs may include information such as vehicle velocity, speed, time, map data (e.g., the HD map 322 of FIG. 3C), location data (e.g., the location of the vehicle 300, such as on a map), direction, location of other vehicles (e.g., an occupancy grid), information about objects and status of objects as perceived by the controller(s) 336, etc. For example, the HMI display 334 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 300 further includes a network interface 324, which may use one or more wireless antenna(s) 326 and/or modem(s) to communicate over one or more networks. For example, the network interface 324 may be capable of communication over LTE, WCDMA, UMTS, GSM, CDMA2000, etc. The wireless antenna(s) 326 may also enable communication between objects in the environment (e.g., vehicles, mobile devices, etc.), using local area network(s), such as Bluetooth, Bluetooth LE, Z-Wave, ZigBee, etc., and/or low power wide-area network(s) (LPWANs), such as LoRaWAN, SigFox, etc.

FIG. 3B is an example of camera locations and fields of view for the example autonomous vehicle 300 of FIG. 3A, in accordance with some embodiments of the present disclosure. The cameras and respective fields of view are one example embodiment and are not intended to be limiting. For example, additional and/or alternative cameras may be included and/or the cameras may be located at different locations on the vehicle 300.

The camera types for the cameras may include, but are not limited to, digital cameras that may be adapted for use with the components and/or systems of the vehicle 300. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red, blue, green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom-designed (3-D printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3-D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 300 (e.g., front-facing cameras) may be used for surround view, to help identify forward-facing paths and obstacles, as well aid in, with the help of one or more controllers 336 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (LDW), Autonomous Cruise Control (ACC), and/or other functions such as traffic sign recognition.

A variety of cameras may be used in a front-facing configuration, including, for example, a monocular camera platform that includes a CMOS (complementary metal oxide semiconductor) color imager. Another example may be a wide-view camera(s) 370 that may be used to perceive objects coming into view from the periphery (e.g., pedestrians, crossing traffic or bicycles). Although only one wide-view camera is illustrated in FIG. 3B, there may any number of wide-view cameras 370 on the vehicle 300. In addition, long-range camera(s) 398 (e.g., a long-view stereo camera pair) may be used for depth-based object detection, especially for objects for which a neural network has not yet been trained. The long-range camera(s) 398 may also be used for object detection and classification, as well as basic object tracking.

One or more stereo cameras 368 may also be included in a front-facing configuration. The stereo camera(s) 368 may include an integrated control unit comprising a scalable processing unit, which may provide a programmable logic (FPGA) and a multi-core micro-processor with an integrated CAN or Ethernet interface on a single chip. Such a unit may be used to generate a 3-D map of the vehicle's environment, including a distance estimate for all the points in the image. An alternative stereo camera(s) 368 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 368 may be used in addition to, or alternatively from, those described herein.

Cameras with a field of view that include portions of the environment to the side of the vehicle 300 (e.g., side-view cameras) may be used for surround view, providing information used to create and update the occupancy grid, as well as to generate side impact collision warnings. For example, surround camera(s) 374 (e.g., four surround cameras 374 as illustrated in FIG. 3B) may be positioned to on the vehicle 300. The surround camera(s) 374 may include wide-view camera(s) 370, fisheye camera(s), 360-degree camera(s), and/or the like. For example, four fisheye cameras may be positioned on the vehicle's front, rear, and sides. In an alternative arrangement, the vehicle may use three surround camera(s) 374 (e.g., left, right, and rear), and may leverage one or more other camera(s) (e.g., a forward-facing camera) as a fourth surround-view camera.

Cameras with a field of view that include portions of the environment to the rear of the vehicle 300 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 398, stereo camera(s) 368), infrared camera(s) 372, etc.), as described herein.

FIG. 3C is a block diagram of an example system architecture for the example autonomous vehicle 300 of FIG. 3A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 300 in FIG. 3C is illustrated as being connected via bus 302. The bus 302 may include a Controller Area Network (CAN) data interface (alternatively referred to herein as a “CAN bus”). A CAN may be a network inside the vehicle 300 used to aid in control of various features and functionality of the vehicle 300, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 302 is described herein as being a CAN bus, this is not intended to be limiting. For example, in addition to, or alternatively from, the CAN bus, FlexRay and/or Ethernet may be used. Additionally, although a single line is used to represent the bus 302, this is not intended to be limiting. For example, there may be any number of busses 302, which may include one or more CAN busses, one or more FlexRay busses, one or more Ethernet busses, and/or one or more other types of busses using a different protocol. In some examples, two or more busses 302 may be used to perform different functions, and/or may be used for redundancy. For example, a first bus 302 may be used for collision avoidance functionality and a second bus 302 may be used for actuation control. In any example, each bus 302 may communicate with any of the components of the vehicle 300, and two or more busses 302 may communicate with the same components. In some examples, each SoC 304, each controller 336, and/or each computer within the vehicle may have access to the same input data (e.g., inputs from sensors of the vehicle 300), and may be connected to a common bus, such the CAN bus.

The vehicle 300 may include one or more controller(s) 336, such as those described herein with respect to FIG. 3A. The controller(s) 336 may be used for a variety of functions. The controller(s) 336 may be coupled to any of the various other components and systems of the vehicle 300 and may be used for control of the vehicle 300, artificial intelligence of the vehicle 300, infotainment for the vehicle 300, and/or the like.

The vehicle 300 may include a system(s) on a chip (SoC) 304. The SoC 304 may include CPU(s) 306, GPU(s) 308, processor(s) 310, cache(s) 312, accelerator(s) 314, data store(s) 316, and/or other components and features not illustrated. The SoC(s) 304 may be used to control the vehicle 300 in a variety of platforms and systems. For example, the SoC(s) 304 may be combined in a system (e.g., the system of the vehicle 300) with an HD map 322 which may obtain map refreshes and/or updates via a network interface 324 from one or more servers (e.g., server(s) 378 of FIG. 3D).

The CPU(s) 306 may include a CPU cluster or CPU complex (alternatively referred to herein as a “CCPLEX”). The CPU(s) 306 may include multiple cores and/or L2 caches. For example, in some embodiments, the CPU(s) 306 may include eight cores in a coherent multi-processor configuration. In some embodiments, the CPU(s) 306 may include four dual-core clusters where each cluster has a dedicated L2 cache (e.g., a 2 MB L2 cache). The CPU(s) 306 (e.g., the CCPLEX) may be configured to support simultaneous cluster operation enabling any combination of the clusters of the CPU(s) 306 to be active at any given time.

The CPU(s) 306 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 306 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 308 may include an integrated GPU (alternatively referred to herein as an “iGPU”). The GPU(s) 308 may be programmable and may be efficient for parallel workloads. The GPU(s) 308, in some examples, may use an enhanced tensor instruction set. The GPU(s) 308 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 308 may include at least eight streaming microprocessors. The GPU(s) 308 may use compute application programming interface(s) (API(s)). In addition, the GPU(s) 308 may use one or more parallel computing platforms and/or programming models (e.g., NVIDIA's CUDA).

The GPU(s) 308 may be power-optimized for best performance in automotive and embedded use cases. For example, the GPU(s) 308 may be fabricated on a Fin field-effect transistor (FinFET). However, this is not intended to be limiting, and the GPU(s) 308 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread-scheduling capability to enable finer-grain synchronization and cooperation between parallel threads. The streaming microprocessors may include a combined L1 data cache and shared memory unit in order to improve performance while simplifying programming.

The GPU(s) 308 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 308 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 308 to access the CPU(s) 306 page tables directly. In such examples, when the GPU(s) 308 memory management unit (MMU) experiences a miss, an address translation request may be transmitted to the CPU(s) 306. In response, the CPU(s) 306 may look in its page tables for the virtual-to-physical mapping for the address and transmits the translation back to the GPU(s) 308. As such, unified memory technology may allow a single unified virtual address space for memory of both the CPU(s) 306 and the GPU(s) 308, thereby simplifying the GPU(s) 308 programming and porting of applications to the GPU(s) 308.

In addition, the GPU(s) 308 may include an access counter that may keep track of the frequency of access of the GPU(s) 308 to memory of other processors. The access counter may help ensure that memory pages are moved to the physical memory of the processor that is accessing the pages most frequently.

The SoC(s) 304 may include any number of cache(s) 312, including those described herein. For example, the cache(s) 312 may include an L3 cache that is available to both the CPU(s) 306 and the GPU(s) 308 (e.g., that is connected to both the CPU(s) 306 and the GPU(s) 308). The cache(s) 312 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 304 may include an arithmetic logic unit(s) (ALU(s)) which may be leveraged in performing processing with respect to any of the variety of tasks or operations of the vehicle 300—such as processing DNNs. In addition, the SoC(s) 304 may include a floating point unit(s) (FPU(s))—or other math coprocessor or numeric coprocessor types—for performing mathematical operations within the system. For example, the SoC(s) 304 may include one or more FPUs integrated as execution units within a CPU(s) 306 and/or GPU(s) 308.

The SoC(s) 304 may include one or more accelerators 314 (e.g., hardware accelerators, software accelerators, or a combination thereof). For example, the SoC(s) 304 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 308 and to off-load some of the tasks of the GPU(s) 308 (e.g., to free up more cycles of the GPU(s) 308 for performing other tasks). As an example, the accelerator(s) 314 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 314 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 308, and by using an inference accelerator, for example, a designer may target either the DLA(s) or the GPU(s) 308 for any function. For example, the designer may focus processing of CNNs and floating point operations on the DLA(s) and leave other functions to the GPU(s) 308 and/or other accelerator(s) 314.

The accelerator(s) 314 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 306. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 314 (e.g., the hardware acceleration cluster) may include a computer vision network on-chip and SRAM, for providing a high-bandwidth, low latency SRAM for the accelerator(s) 314. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 304 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 314 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to processed RADAR. In other examples, the PVA is used for time of flight depth processing, by processing raw time of flight data to provide processed time of flight data, for example.

The DLA may be used to run any type of network to enhance control and driving safety, including, for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 366 output that correlates with the vehicle 300 orientation, distance, 3D location estimates of the object obtained from the neural network and/or other sensors (e.g., LIDAR sensor(s) 364 or RADAR sensor(s) 360), among others.

The SoC(s) 304 may include data store(s) 316 (e.g., memory). The data store(s) 316 may be on-chip memory of the SoC(s) 304, which may store neural networks to be executed on the GPU and/or the DLA. In some examples, the data store(s) 316 may be large enough in capacity to store multiple instances of neural networks for redundancy and safety. The data store(s) 316 may comprise L2 or L3 cache(s) 312. Reference to the data store(s) 316 may include reference to the memory associated with the PVA, DLA, and/or other accelerator(s) 314, as described herein.

The SoC(s) 304 may include one or more processor(s) 310 (e.g., embedded processors). The processor(s) 310 may include a boot and power management processor that may be a dedicated processor and subsystem to handle boot power and management functions and related security enforcement. The boot and power management processor may be a part of the SoC(s) 304 boot sequence and may provide runtime power management services. The boot power and management processor may provide clock and voltage programming, assistance in system low power state transitions, management of SoC(s) 304 thermals and temperature sensors, and/or management of the SoC(s) 304 power states. Each temperature sensor may be implemented as a ring-oscillator whose output frequency is proportional to temperature, and the SoC(s) 304 may use the ring-oscillators to detect temperatures of the CPU(s) 306, GPU(s) 308, and/or accelerator(s) 314. If temperatures are determined to exceed a threshold, the boot and power management processor may enter a temperature fault routine and put the SoC(s) 304 into a lower power state and/or put the vehicle 300 into a chauffeur to safe-stop mode (e.g., bring the vehicle 300 to a safe stop).

The processor(s) 310 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 310 may further include an always-on processor engine that may provide necessary hardware features to support low power sensor management and wake use cases. The always-on processor engine may include a processor core, a tightly coupled RAM, supporting peripherals (e.g., timers and interrupt controllers), various I/O controller peripherals, and routing logic.

The processor(s) 310 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 310 may further include a real-time camera engine that may include a dedicated processor subsystem for handling real-time camera management.

The processor(s) 310 may further include a high dynamic range signal processor that may include an image signal processor that is a hardware engine that is part of the camera processing pipeline.

The processor(s) 310 may include a video image compositor that may be a processing block (e.g., implemented on a microprocessor) that implements video post-processing functions needed by a video playback application to produce the final image for the player window. The video image compositor may perform lens distortion correction on wide-view camera(s) 370, surround camera(s) 374, and/or on in-cabin monitoring camera sensors. An in-cabin monitoring camera sensor is preferably monitored by a neural network running on another instance of the Advanced SoC, configured to identify in-cabin events and respond accordingly. In-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 308 is not required to continuously render new surfaces. Even when the GPU(s) 308 is powered on and active doing 3D rendering, the video image compositor may be used to offload the GPU(s) 308 to improve performance and responsiveness.

The SoC(s) 304 may further include a mobile industry processor interface (MIPI) camera serial interface for receiving video and input from cameras, a high-speed interface, and/or a video input block that may be used for camera and related pixel input functions. The SoC(s) 304 may further include an input/output controller(s) that may be controlled by software and may be used for receiving I/O signals that are uncommitted to a specific role.

The SoC(s) 304 may further include a broad range of peripheral interfaces to enable communication with peripherals, audio codecs, power management, and/or other devices. The SoC(s) 304 may be used to process data from cameras (e.g., connected over Gigabit Multimedia Serial Link and Ethernet), sensors (e.g., LIDAR sensor(s) 364, RADAR sensor(s) 360, etc. that may be connected over Ethernet), data from bus 302 (e.g., speed of vehicle 300, steering wheel position, etc.), data from GNSS sensor(s) 358 (e.g., connected over Ethernet or CAN bus). The SoC(s) 304 may further include dedicated high-performance mass storage controllers that may include their own DMA engines, and that may be used to free the CPU(s) 306 from routine data management tasks.

The SoC(s) 304 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 304 may be faster, more reliable, and even more energy-efficient and space-efficient than conventional systems. For example, the accelerator(s) 314, when combined with the CPU(s) 306, the GPU(s) 308, and the data store(s) 316, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 320) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path-planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path-planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 308.

In some examples, a CNN for facial recognition and vehicle owner identification may use data from camera sensors to identify the presence of an authorized driver and/or owner of the vehicle 300. The always-on sensor processing engine may be used to unlock the vehicle when the owner approaches the driver door and turn on the lights, and, in security mode, to disable the vehicle when the owner leaves the vehicle. In this way, the SoC(s) 304 provide for security against theft and/or carjacking.

In another example, a CNN for emergency vehicle detection and identification may use data from microphones 396 to detect and identify emergency vehicle sirens. In contrast to conventional systems, that use general classifiers to detect sirens and manually extract features, the SoC(s) 304 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 358. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 362, until the emergency vehicle(s) passes.

The vehicle may include a CPU(s) 318 (e.g., discrete CPU(s), or dCPU(s)), that may be coupled to the SoC(s) 304 via a high-speed interconnect (e.g., PCIe). The CPU(s) 318 may include an X86 processor, for example. The CPU(s) 318 may be used to perform any of a variety of functions, including arbitrating potentially inconsistent results between ADAS sensors and the SoC(s) 304, and/or monitoring the status and health of the controller(s) 336 and/or infotainment SoC 330, for example.

The vehicle 300 may include a GPU(s) 320 (e.g., discrete GPU(s), or dGPU(s)), that may be coupled to the SoC(s) 304 via a high-speed interconnect (e.g., NVIDIA's NVLINK). The GPU(s) 320 may provide additional artificial intelligence functionality, such as by executing redundant and/or different neural networks, and may be used to train and/or update neural networks based on input (e.g., sensor data) from sensors of the vehicle 300.

The vehicle 300 may further include the network interface 324 which may include one or more wireless antennas 326 (e.g., one or more wireless antennas for different communication protocols, such as a cellular antenna, a Bluetooth antenna, etc.). The network interface 324 may be used to enable wireless connectivity over the Internet with the cloud (e.g., with the server(s) 378 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 300 information about vehicles in proximity to the vehicle 300 (e.g., vehicles in front of, on the side of, and/or behind the vehicle 300). This functionality may be part of a cooperative adaptive cruise control functionality of the vehicle 300.

The network interface 324 may include a SoC that provides modulation and demodulation functionality and enables the controller(s) 336 to communicate over wireless networks. The network interface 324 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 300 may further include data store(s) 328, which may include off-chip (e.g., off the SoC(s) 304) storage. The data store(s) 328 may include one or more storage elements including RAM, SRAM, DRAM, VRAM, Flash, hard disks, and/or other components and/or devices that may store at least one bit of data.

The vehicle 300 may further include GNSS sensor(s) 358. The GNSS sensor(s) 358 (e.g., GPS, assisted GPS sensors, differential GPD (DGPS) sensors, etc.), to assist in mapping, perception, occupancy grid generation, and/or path planning functions. Any number of GNSS sensor(s) 358 may be used, including, for example and without limitation, a GPS using a USB connector with an Ethernet to Serial (RS-232) bridge.

The vehicle 300 may further include RADAR sensor(s) 360. The RADAR sensor(s) 360 may be used by the vehicle 300 for long-range vehicle detection, even in darkness and/or severe weather conditions. RADAR functional safety levels may be ASIL B. The RADAR sensor(s) 360 may use the CAN and/or the bus 302 (e.g., to transmit data generated by the RADAR sensor(s) 360) for control and to access object tracking data, with access to Ethernet to access raw data, in some examples. A wide variety of RADAR sensor types may be used. For example, and without limitation, the RADAR sensor(s) 360 may be suitable for front, rear, and side RADAR use. In some example, Pulse Doppler RADAR sensor(s) are used.

The RADAR sensor(s) 360 may include different configurations, such as long-range with narrow field of view, short-range with wide field of view, short-range side coverage, etc. In some examples, long-range RADAR may be used for adaptive cruise control functionality. The long-range RADAR systems may provide a broad field of view realized by two or more independent scans, such as within a 250 m range. The RADAR sensor(s) 360 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 300 surrounding at higher speeds with minimal interference from traffic in adjacent lanes. The other two antennae may expand the field of view, making it possible to quickly detect vehicles entering or leaving the vehicle's 300 lane.

Mid-range RADAR systems may include, as an example, a range of up to 160 m (front) or 80 m (rear), and a field of view of up to 42 degrees (front) or 150 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 300 may further include ultrasonic sensor(s) 362. The ultrasonic sensor(s) 362, which may be positioned at the front, back, and/or the sides of the vehicle 300, may be used for park assist and/or to create and update an occupancy grid. A wide variety of ultrasonic sensor(s) 362 may be used, and different ultrasonic sensor(s) 362 may be used for different ranges of detection (e.g., 2.5 m, 4 m). The ultrasonic sensor(s) 362 may operate at functional safety levels of ASIL B.

The vehicle 300 may include LIDAR sensor(s) 364. The LIDAR sensor(s) 364 may be used for object and pedestrian detection, emergency braking, collision avoidance, and/or other functions. The LIDAR sensor(s) 364 may be functional safety level ASIL B. In some examples, the vehicle 300 may include multiple LIDAR sensors 364 (e.g., two, four, six, etc.) that may use Ethernet (e.g., to provide data to a Gigabit Ethernet switch).

In some examples, the LIDAR sensor(s) 364 may be capable of providing a list of objects and their distances for a 360-degree field of view. Commercially available LIDAR sensor(s) 364 may have an advertised range of approximately 100 m, with an accuracy of 2 cm-3 cm, and with support for a 100 Mbps Ethernet connection, for example. In some examples, one or more non-protruding LIDAR sensors 364 may be used. In such examples, the LIDAR sensor(s) 364 may be implemented as a small device that may be embedded into the front, rear, sides, and/or corners of the vehicle 300. The LIDAR sensor(s) 364, in such examples, may provide up to a 120-degree horizontal and 35-degree vertical field-of-view, with a 200 m range even for low-reflectivity objects. Front-mounted LIDAR sensor(s) 364 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 300. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 364 may be less susceptible to motion blur, vibration, and/or shock.

The vehicle may further include IMU sensor(s) 366. The IMU sensor(s) 366 may be located at a center of the rear axle of the vehicle 300, in some examples. The IMU sensor(s) 366 may include, for example and without limitation, an accelerometer(s), a magnetometer(s), a gyroscope(s), a magnetic compass(es), and/or other sensor types. In some examples, such as in six-axis applications, the IMU sensor(s) 366 may include accelerometers and gyroscopes, while in nine-axis applications, the IMU sensor(s) 366 may include accelerometers, gyroscopes, and magnetometers.

In some embodiments, the IMU sensor(s) 366 may be implemented as a miniature, high-performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 366 may enable the vehicle 300 to estimate heading without requiring input from a magnetic sensor by directly observing and correlating the changes in velocity from GPS to the IMU sensor(s) 366. In some examples, the IMU sensor(s) 366 and the GNSS sensor(s) 358 may be combined in a single integrated unit.

The vehicle may include microphone(s) 396 placed in and/or around the vehicle 300. The microphone(s) 396 may be used for emergency vehicle detection and identification, among other things.

The vehicle may further include any number of camera types, including stereo camera(s) 368, wide-view camera(s) 370, infrared camera(s) 372, surround camera(s) 374, long-range and/or mid-range camera(s) 398, and/or other camera types. The cameras may be used to capture image data around an entire periphery of the vehicle 300. The types of cameras used depends on the embodiments and requirements for the vehicle 300, and any combination of camera types may be used to provide the necessary coverage around the vehicle 300. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 3A and FIG. 3B.

The vehicle 300 may further include vibration sensor(s) 342. The vibration sensor(s) 342 may measure vibrations of components of the vehicle, such as the axle(s). For example, changes in vibrations may indicate a change in road surfaces. In another example, when two or more vibration sensors 342 are used, the differences between the vibrations may be used to determine friction or slippage of the road surface (e.g., when the difference in vibration is between a power-driven axle and a freely rotating axle).

The vehicle 300 may include an ADAS system 338. The ADAS system 338 may include a SoC, in n some examples. The ADAS system 338 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 360, LIDAR sensor(s) 364, and/or a camera(s). The ACC systems may include longitudinal ACC and/or lateral ACC. Longitudinal ACC monitors and controls the distance to the vehicle immediately ahead of the vehicle 300 and automatically adjust the vehicle speed to maintain a safe distance from vehicles ahead. Lateral ACC performs distance keeping, and advises the vehicle 300 to change lanes when necessary. Lateral ACC is related to other ADAS applications such as LCA and CWS.

CACC uses information from other vehicles that may be received via the network interface 324 and/or the wireless antenna(s) 326 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 300), while the I2V communication concept provides information about traffic further ahead. CACC systems may include either or both I2V and V2V information sources. Given the information of the vehicles ahead of the vehicle 300, CACC may be more reliable, and it has potential to improve traffic flow smoothness and reduce congestion on the road.

FCW systems are designed to alert the driver to a hazard, so that the driver may take corrective action. FCW systems use a front-facing camera and/or RADAR sensor(s) 360, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 360, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 300 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 300 if the vehicle 300 starts to exit the lane. BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s).

RCTW systems may provide visual, audible, and/or tactile notification when an object is detected outside the rear-camera range when the vehicle 300 is backing up. Some RCTW systems include AEB to ensure that the vehicle brakes are applied to avoid a crash. RCTW systems may use one or more rear-facing RADAR sensor(s) 360, coupled to a dedicated processor, DSP, FPGA, and/or ASIC, that is electrically coupled to driver feedback, such as a display, speaker, and/or vibrating component.

Conventional ADAS systems may be prone to false positive results, which may be annoying and distracting to a driver, but typically are not catastrophic, because the ADAS systems alert the driver and allow the driver to decide whether a safety condition truly exists and act accordingly. However, in an autonomous vehicle 300, the vehicle 300 itself must, in the case of conflicting results, decide whether to heed the result from a primary computer or a secondary computer (e.g., a first controller 336 or a second controller 336). For example, in some embodiments, the ADAS system 338 may be a backup and/or secondary computer for providing perception information to a backup computer rationality module. The backup computer rationality monitor may run a redundant diverse software on hardware components to detect faults in perception and dynamic driving tasks. Outputs from the ADAS system 338 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 304.

In other examples, ADAS system 338 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 338 may be fed into the primary computer's perception block and/or the primary computer's dynamic driving task block. For example, if the ADAS system 338 indicates a forward crash warning due to an object immediately ahead, the perception block may use this information when identifying objects. In other examples, the secondary computer may have its own neural network that is trained and thus reduces the risk of false positives, as described herein.

The vehicle 300 may further include the infotainment SoC 330 (e.g., an in-vehicle infotainment system (IVI)). Although illustrated and described as an SoC, the infotainment system may not be a SoC, and may include two or more discrete components. The infotainment SoC 330 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle-related information such as fuel level, total distance covered, brake fuel level, oil level, door open/close, air filter information, etc.) to the vehicle 300. For example, the infotainment SoC 330 may include radios, disk players, navigation systems, video players, USB and Bluetooth connectivity, carputers, in-car entertainment, Wi-Fi, steering wheel audio controls, hands-free voice control, a heads-up display (HUD), an HMI display 334, a telematics device, a control panel (e.g., for controlling and/or interacting with various components, features, and/or systems), and/or other components. The infotainment SoC 330 may further be used to provide information (e.g., visual and/or audible) to a user(s) of the vehicle, such as information from the ADAS system 338, autonomous driving information such as planned vehicle maneuvers, trajectories, surrounding environment information (e.g., intersection information, vehicle information, road information, etc.), and/or other information.

The infotainment SoC 330 may include GPU functionality. The infotainment SoC 330 may communicate over the bus 302 (e.g., CAN bus, Ethernet, etc.) with other devices, systems, and/or components of the vehicle 300. In some examples, the infotainment SoC 330 may be coupled to a supervisory MCU such that the GPU of the infotainment system may perform some self-driving functions in the event that the primary controller(s) 336 (e.g., the primary and/or backup computers of the vehicle 300) fail. In such an example, the infotainment SoC 330 may put the vehicle 300 into a chauffeur to safe-stop mode, as described herein.

The vehicle 300 may further include an instrument cluster 332 (e.g., a digital dash, an electronic instrument cluster, a digital instrument panel, etc.). The instrument cluster 332 may include a controller and/or supercomputer (e.g., a discrete controller or supercomputer). The instrument cluster 332 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 330 and the instrument cluster 332. In other words, the instrument cluster 332 may be included as part of the infotainment SoC 330, or vice versa.

FIG. 3D is a system diagram for communication between cloud-based server(s) and the example autonomous vehicle 300 of FIG. 3A, in accordance with some embodiments of the present disclosure. The system 376 may include server(s) 378, network(s) 390, and vehicles, including the vehicle 300. The server(s) 378 may include a plurality of GPUs 384(A)-384(H) (collectively referred to herein as GPUs 384), PCIe switches 382(A)-382(H) (collectively referred to herein as PCIe switches 382), and/or CPUs 380(A)-380(B) (collectively referred to herein as CPUs 380). The GPUs 384, the CPUs 380, and the PCIe switches may be interconnected with high-speed interconnects such as, for example and without limitation, NVLink interfaces 388 developed by NVIDIA and/or PCIe connections 386. In some examples, the GPUs 384 are connected via NVLink and/or NVSwitch SoC and the GPUs 384 and the PCIe switches 382 are connected via PCIe interconnects. Although eight GPUs 384, two CPUs 380, and two PCIe switches are illustrated, this is not intended to be limiting. Depending on the embodiment, each of the server(s) 378 may include any number of GPUs 384, CPUs 380, and/or PCIe switches. For example, the server(s) 378 may each include eight, sixteen, thirty-two, and/or more GPUs 384.

The server(s) 378 may receive, over the network(s) 390 and from the vehicles, image data representative of images showing unexpected or changed road conditions, such as recently commenced road work. The server(s) 378 may transmit, over the network(s) 390 and to the vehicles, neural networks 392, updated neural networks 392, and/or map information 394, including information regarding traffic and road conditions. The updates to the map information 394 may include updates for the HD map 322, such as information regarding construction sites, potholes, detours, flooding, and/or other obstructions. In some examples, the neural networks 392, the updated neural networks 392, and/or the map information 394 may have resulted from new training and/or experiences represented in data received from any number of vehicles in the environment, and/or based on training performed at a datacenter (e.g., using the server(s) 378 and/or other servers).

The server(s) 378 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 390, and/or the machine learning models may be used by the server(s) 378 to remotely monitor the vehicles.

In some examples, the server(s) 378 may receive data from the vehicles and apply the data to up-to-date real-time neural networks for real-time intelligent inferencing. The server(s) 378 may include deep-learning supercomputers and/or dedicated AI computers powered by GPU(s) 384, such as a DGX and DGX Station machines developed by NVIDIA. However, in some examples, the server(s) 378 may include deep learning infrastructure that use only CPU-powered datacenters.

The deep-learning infrastructure of the server(s) 378 may be capable of fast, real-time inferencing, and may use that capability to evaluate and verify the health of the processors, software, and/or associated hardware in the vehicle 300. For example, the deep-learning infrastructure may receive periodic updates from the vehicle 300, such as a sequence of images and/or objects that the vehicle 300 has located in that sequence of images (e.g., via computer vision and/or other machine learning object classification techniques). The deep-learning infrastructure may run its own neural network to identify the objects and compare them with the objects identified by the vehicle 300 and, if the results do not match and the infrastructure concludes that the AI in the vehicle 300 is malfunctioning, the server(s) 378 may transmit a signal to the vehicle 300 instructing a fail-safe computer of the vehicle 300 to assume control, notify the passengers, and complete a safe parking maneuver.

For inferencing, the server(s) 378 may include the GPU(s) 384 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 4 is a block diagram of an example computing device(s) 400 suitable for use in implementing some embodiments of the present disclosure. Computing device 400 may include an interconnect system 402 that directly or indirectly couples the following devices: memory 404, one or more central processing units (CPUs) 406, one or more graphics processing units (GPUs) 408, a communication interface 410, input/output (I/O) ports 412, input/output components 414, a power supply 416, one or more presentation components 418 (e.g., display(s)), and one or more logic units 420. In at least one embodiment, the computing device(s) 400 may comprise one or more virtual machines (VMs), and/or any of the components thereof may comprise virtual components (e.g., virtual hardware components). For non-limiting examples, one or more of the GPUs 408 may comprise one or more vGPUs, one or more of the CPUs 406 may comprise one or more vCPUs, and/or one or more of the logic units 420 may comprise one or more virtual logic units. As such, a computing device(s) 400 may include discrete components (e.g., a full GPU dedicated to the computing device 400), virtual components (e.g., a portion of a GPU dedicated to the computing device 400), or a combination thereof.

Although the various blocks of FIG. 4 are shown as connected via the interconnect system 402 with lines, this is not intended to be limiting and is for clarity only. For example, in some embodiments, a presentation component 418, such as a display device, may be considered an I/O component 414 (e.g., if the display is a touch screen). As another example, the CPUs 406 and/or GPUs 408 may include memory (e.g., the memory 404 may be representative of a storage device in addition to the memory of the GPUs 408, the CPUs 406, and/or other components). In other words, the computing device of FIG. 4 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 4.

The interconnect system 402 may represent one or more links or busses, such as an address bus, a data bus, a control bus, or a combination thereof. The interconnect system 402 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 406 may be directly connected to the memory 404. Further, the CPU 406 may be directly connected to the GPU 408. Where there is direct, or point-to-point, connection between components, the interconnect system 402 may include a PCIe link to carry out the connection. In these examples, a PCI bus need not be included in the computing device 400.

The memory 404 may include any of a variety of computer-readable media. The computer-readable media may be any available media that may be accessed by the computing device 400. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 404 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 400. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 406 may be configured to execute at least some of the computer-readable instructions to control one or more components of the computing device 400 to perform one or more of the methods and/or processes described herein. The CPU(s) 406 may each include one or more cores (e.g., one, two, four, eight, twenty-eight, seventy-two, etc.) that are capable of handling a multitude of software threads simultaneously. The CPU(s) 406 may include any type of processor, and may include different types of processors depending on the type of computing device 400 implemented (e.g., processors with fewer cores for mobile devices and processors with more cores for servers). For example, depending on the type of computing device 400, the processor may be an Advanced RISC Machines (ARM) processor implemented using Reduced Instruction Set Computing (RISC) or an x86 processor implemented using Complex Instruction Set Computing (CISC). The computing device 400 may include one or more CPUs 406 in addition to one or more microprocessors or supplementary co-processors, such as math co-processors.

In addition to or alternatively from the CPU(s) 406, the GPU(s) 408 may be configured to execute at least some of the computer-readable instructions to control one or more components of the computing device 400 to perform one or more of the methods and/or processes described herein. One or more of the GPU(s) 408 may be an integrated GPU (e.g., with one or more of the CPU(s) 406 and/or one or more of the GPU(s) 408 may be a discrete GPU. In embodiments, one or more of the GPU(s) 408 may be a coprocessor of one or more of the CPU(s) 406. The GPU(s) 408 may be used by the computing device 400 to render graphics (e.g., 3D graphics) or perform general purpose computations. For example, the GPU(s) 408 may be used for General-Purpose computing on GPUs (GPGPU). The GPU(s) 408 may include hundreds or thousands of cores that are capable of handling hundreds or thousands of software threads simultaneously. The GPU(s) 408 may generate pixel data for output images in response to rendering commands (e.g., rendering commands from the CPU(s) 406 received via a host interface). The GPU(s) 408 may include graphics memory, such as display memory, for storing pixel data or any other suitable data, such as GPGPU data. The display memory may be included as part of the memory 404. The GPU(s) 408 may include two or more GPUs operating in parallel (e.g., via a link). The link may directly connect the GPUs (e.g., using NVLINK) or may connect the GPUs through a switch (e.g., using NVSwitch). When combined together, each GPU 408 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 406 and/or the GPU(s) 408, the logic unit(s) 420 may be configured to execute at least some of the computer-readable instructions to control one or more components of the computing device 400 to perform one or more of the methods and/or processes described herein. In embodiments, the CPU(s) 406, the GPU(s) 408, and/or the logic unit(s) 420 may discretely or jointly perform any combination of the methods, processes and/or portions thereof. One or more of the logic units 420 may be part of and/or integrated in one or more of the CPU(s) 406 and/or the GPU(s) 408 and/or one or more of the logic units 420 may be discrete components or otherwise external to the CPU(s) 406 and/or the GPU(s) 408. In embodiments, one or more of the logic units 420 may be a coprocessor of one or more of the CPU(s) 406 and/or one or more of the GPU(s) 408.

Examples of the logic unit(s) 420 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Trec Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 410 may include one or more receivers, transmitters, and/or transceivers that enable the computing device 400 to communicate with other computing devices via an electronic communication network, include wired and/or wireless communications. The communication interface 410 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 420 and/or communication interface 410 may include one or more data processing units (DPUs) to transmit data received over a network and/or through interconnect system 402 directly to (e.g., a memory of) one or more GPU(s) 408.

The I/O ports 412 may enable the computing device 400 to be logically coupled to other devices including the I/O components 414, the presentation component(s) 418, and/or other components, some of which may be built in to (e.g., integrated in) the computing device 400. Illustrative I/O components 414 include a microphone, mouse, keyboard, joystick, game pad, game controller, satellite dish, scanner, printer, wireless device, etc. The I/O components 414 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail in the present disclosure) associated with a display of the computing device 400. The computing device 400 may include depth cameras, such as stereoscopic camera systems, infrared camera systems, RGB camera systems, touchscreen technology, and combinations of these, for gesture detection and recognition. Additionally, the computing device 400 may include accelerometers or gyroscopes (e.g., as part of an inertia measurement unit (IMU)) that enable detection of motion. In some examples, the output of the accelerometers or gyroscopes may be used by the computing device 400 to render immersive augmented reality or virtual reality.

The power supply 416 may include a hard-wired power supply, a battery power supply, or a combination thereof. The power supply 416 may provide power to the computing device 400 to enable the components of the computing device 400 to operate.

The presentation component(s) 418 may include a display (e.g., a monitor, a touch screen, a television screen, a heads-up-display (HUD), other display types, or a combination thereof), speakers, and/or other presentation components. The presentation component(s) 418 may receive data from other components (e.g., the GPU(s) 408, the CPU(s) 406, etc.), and output the data (e.g., as an image, video, sound, etc.).

### Example Data Center

FIG. 5 illustrates an example data center 500 that may be used in at least one embodiments of the present disclosure. The data center 500 may include a data center infrastructure layer 510, a framework layer 520, a software layer 530, and/or an application layer 540.

As shown in FIG. 5, the data center infrastructure layer 510 may include a resource orchestrator 512, grouped computing resources 514, and node computing resources (“node C.R.s”) 516(1)-516(N), where “N” represents any whole, positive integer. In at least one embodiment, node C.R.s 516(1)-516(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 516(1)-516(N) may correspond to a server having one or more of the above-mentioned computing resources. In addition, in some embodiments, the node C.R.s 516(1)-516(N) may include one or more virtual components, such as vGPUs, vCPUs, and/or the like, and/or one or more of the node C.R.s 516(1)-516(N) may correspond to a virtual machine (VM).

In at least one embodiment, grouped computing resources 514 may include separate groupings of node C.R.s 516 housed within one or more racks (not shown), or many racks housed in data centers at various geographical locations (also not shown). Separate groupings of node C.R.s 516 within grouped computing resources 514 may include grouped compute, network, memory or storage resources that may be configured or allocated to support one or more workloads. In at least one embodiment, several node C.R.s 516 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 512 may configure or otherwise control one or more node C.R.s 516(1)-516(N) and/or grouped computing resources 514. In at least one embodiment, resource orchestrator 512 may include a software design infrastructure (SDI) management entity for the data center 500. The resource orchestrator 512 may include hardware, software, or some combination thereof.

In at least one embodiment, as shown in FIG. 5, framework layer 520 may include a job scheduler 532, a configuration manager 534, a resource manager 536, and/or a distributed file system 538. The framework layer 520 may include a framework to support software 532 of software layer 530 and/or one or more application(s) 542 of application layer 540. The software 532 or application(s) 542 may respectively include web-based service software or applications, such as those provided by Amazon Web Services, Google Cloud and Microsoft Azure. The framework layer 520 may be, but is not limited to, a type of free and open-source software web application framework such as Apache Spark™ (hereinafter “Spark”) that may utilize distributed file system 538 for large-scale data processing (e.g., “big data”). In at least one embodiment, job scheduler 532 may include a Spark driver to facilitate scheduling of workloads supported by various layers of data center 500. The configuration manager 534 may be capable of configuring different layers such as software layer 530 and framework layer 520 including Spark and distributed file system 538 for supporting large-scale data processing. The resource manager 536 may be capable of managing clustered or grouped computing resources mapped to or allocated for support of distributed file system 538 and job scheduler 532. In at least one embodiment, clustered or grouped computing resources may include grouped computing resource 514 at data center infrastructure layer 510. The resource manager 536 may coordinate with resource orchestrator 512 to manage these mapped or allocated computing resources.

In at least one embodiment, software 532 included in software layer 530 may include software used by at least portions of node C.R.s 516(1)-516(N), grouped computing resources 514, and/or distributed file system 538 of framework layer 520. One or more types of software may include, but are not limited to, Internet web page search software, e-mail virus scan software, database software, and streaming video content software.

In at least one embodiment, application(s) 542 included in application layer 540 may include one or more types of applications used by at least portions of node C.R.s 516(1)-516(N), grouped computing resources 514, and/or distributed file system 538 of framework layer 520. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 534, resource manager 536, and resource orchestrator 512 may implement any number and type of self-modifying actions based on any amount and type of data acquired in any technically feasible fashion. Self-modifying actions may relieve a data center operator of data center 500 from making possibly bad configuration decisions and possibly avoiding underutilized and/or poor performing portions of a data center.

The data center 500 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described in the present disclosure with respect to the data center 500. In at least one embodiment, trained or deployed machine learning models corresponding to one or more neural networks may be used to infer or predict information using resources described in the present disclosure with respect to the data center 500 by using weight parameters calculated through one or more training techniques, such as but not limited to those described herein.

In at least one embodiment, the data center 500 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described in the present disclosure may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 400 of FIG. 4—e.g., each device may include similar components, features, and/or functionality of the computing device(s) 400. In addition, where backend devices (e.g., servers, NAS, etc.) are implemented, the backend devices may be included as part of a data center 500, an example of which is described in more detail herein with respect to FIG. 5.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 400 described herein with respect to FIG. 4. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to codes that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B. Additionally, use of the term “based on” should not be interpreted as “only based on” or “based only on.” Rather, a first element being “based on” a second element includes instances in which the first element is based on the second element but may also be based on one or more additional elements.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The subject technology of the present disclosure is illustrated, for example, according to various aspects described below. Various examples of aspects of the present disclosure are described as numbered examples (1, 2, 3, etc.) for convenience. These are provided as examples and do not limit the present disclosure. The aspects of the various implementations described herein may be omitted, substituted for aspects of other implementations, or combined with aspects of other implementations unless context dictates otherwise. For example, one or more aspects of example 1 below may be omitted, substituted for one or more aspects of another example (e.g., example 2) or examples, or combined with aspects of another example The following is a non-limiting summary of some example implementations presented herein.

Example 1. A system comprising:
a first memory to store a test image for testing a computing system, the test image including a plurality of control packets;
a second memory to store at least:
   a first test configuration indicating a first execution order corresponding to a first set of control packets from the plurality of control packets; and
   a second test configuration indicating a second execution order corresponding to a second set of control packets from the plurality of control packets; and
a hardware controller communicatively coupled to the first memory and the second memory, the hardware controller to direct, based at least on the test image and one of the first test configuration or the second test configuration, execution of at least one of a first test corresponding to the first test configuration or a second test corresponding to the second test configuration.

The system of Example 1, wherein the first test configuration indicates execution of the first set of control packets in a first execution order that differs from a default execution order of the first set of control packets as indicated by the test image.

The system of Example 1, wherein the execution of the first test includes the hardware controller directing execution of one or more control packets of the plurality of control packets based at least on a default execution order of the one or more control packets, as indicated by the test image, in response to the first set of control packets not including the one or more control packets.

The system of Example 1, wherein:
a memory location of the second memory includes a first field and a second field;
the first field includes a first entry of the first test configuration that indicates a first control packet of the first set of control packets;
the second field includes a second entry of the first test configuration that indicates a second control packet of the first set of control packets; and
the execution of the first test includes the hardware controller directing that the second control packet be executed immediately after execution of the first control packet based at least on the first entry and the second entry.

The system of Example 1, wherein the second memory includes a register bank that includes one or more registers.

The system of Example 1, wherein one or more of the first test or the second test corresponds to only a subset of the plurality of control packets.

The system of Example 1, wherein one or more of the first test or the second test corresponds to all of the control packets of the plurality of control packets.

The system of Example 1, wherein one or more of the first set of control packets or the second set of control packets includes all of the control packets executed during the first test or the second test, respectively.

The system of Example 1, wherein one or more of the first set of control packets or the second set of control packets is a subset of the control packets executed during the first test or the second test, respectively.

The system of Example 1, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system for performing one or more generative AI operations;
a system implementing one or more large language models (LLMs);
a system implementing one or more vision language models (VLMs);
a system implementing one or more multi-modal language models;
a system for generating synthetic data;
a system incorporating one or more virtual machines (VMs);
a system implemented at least partially in a data center; or
a system implemented at least partially using cloud computing resources.

Example 2: A system comprising:
memory to store a test image for testing a computing system, the test image including a plurality of control packets sequentially ordered for execution in a linked list;
a register bank including one or more registers, the register bank to:
   store a first test configuration that corresponds to a first test of the computing system and that corresponds to a first set of control packets of the plurality of control packets, the first test configuration indicating execution of the first set of control packets in a first execution order that differs from the sequential ordering of the first set of control packets in the linked list; and
a hardware controller communicatively coupled to the memory and the register bank and to direct execution of the first test based at least on the test image and the first test configuration.

The system of Example 2, wherein:
the register bank is further to:
   store a second test configuration that corresponds to a second test of the computing system and that corresponds to a second set of control packets of the plurality of control packets, the second test configuration indicting execution of the second set of control packets in a second execution order that differs from the sequential ordering of the second set of control packets in the linked list; and
the hardware controller is further to direct execution of the second test based at least on the test image and the second test configuration.

The system of Example 2, wherein the first test corresponds to:
only a subset of the plurality of control packets; or
all of the control packets of the plurality of control packets.

The system of Example 2, wherein:
the first set of control packets includes all of the control packets executed during the first test; or
the first set of control packets is a subset of the control packets executed during the first test.

The system of Example 2, wherein execution of the first test includes the hardware controller directing execution of one or more control packets of the plurality of control packets based at least on the linked list in response to the first set of control packets not including the one or more control packets.

The system of Example 2, wherein:
a register of the register bank includes a first field and a second field;
the first field includes a first entry of the first test configuration that indicates a first control packet of the first set of control packets;
the second field includes a second entry of the first test configuration that indicates a second control packet of the first set of control packets; and
execution of the first test includes the hardware controller directing that the second control packet be executed immediately after execution of the first control packet based at least on the first entry and the second entry.

Example 3: A method comprising:
accessing a test image that is for testing a computing system, the test image indicating a default execution order for a plurality of control packets while testing the computing system;
accessing a test configuration that corresponds to a test of the computing system and that corresponds to a set of control packets of the plurality of control packets, the test configuration indicating execution of the set of control packets in an execution order that differs from the default execution order; and
performing the test of the computing system based at least on the test image and the test configuration.

The method of Example 3, wherein the default execution order is based at least on a sequential ordering of the plurality of control packets as indicated by a linked list included in the test image.

The method of Example 3, wherein the test configuration is accessed from a register bank that includes one or more registers and that is loaded with the test configuration.

The method of Example 3, wherein the test image is accessed from a memory that is loaded with the test image and that is separate from the register bank.

What is claimed is:

1. A system comprising:
a first memory to store a test image for testing a computing system, the test image including a plurality of control packets;
a second memory to store at least:
a first test configuration indicating a first execution order corresponding to a first set of control packets from the plurality of control packets; and
a second test configuration indicating a second execution order corresponding to a second set of control packets from the plurality of control packets; and
a hardware controller communicatively coupled to the first memory and the second memory, the hardware controller to direct, based at least on the test image and one of the first test configuration or the second test configuration, execution of at least one of a first test corresponding to the first test configuration or a second test corresponding to the second test configuration.

2. The system of claim 1, wherein the first test configuration indicates execution of the first set of control packets in a first execution order that differs from a default execution order of the first set of control packets as indicated by the test image.

3. The system of claim 1, wherein the execution of the first test includes the hardware controller directing execution of one or more control packets of the plurality of control packets based at least on a default execution order of the one or more control packets, as indicated by the test image, in response to the first set of control packets not including the one or more control packets.

4. The system of claim 1, wherein:
a memory location of the second memory includes a first field and a second field;
the first field includes a first entry of the first test configuration that indicates a first control packet of the first set of control packets;
the second field includes a second entry of the first test configuration that indicates a second control packet of the first set of control packets; and
the execution of the first test includes the hardware controller directing that the second control packet be executed immediately after execution of the first control packet based at least on the first entry and the second entry.

5. The system of claim 1, wherein the second memory includes a register bank that includes one or more registers.

6. The system of claim 1, wherein one or more of the first test or the second test corresponds to only a subset of the plurality of control packets.

7. The system of claim 1, wherein one or more of the first test or the second test corresponds to all of the control packets of the plurality of control packets.

8. The system of claim 1, wherein one or more of the first set of control packets or the second set of control packets includes all of the control packets executed during the first test or the second test, respectively.

9. The system of claim 1, wherein one or more of the first set of control packets or the second set of control packets is a subset of the control packets executed during the first test or the second test, respectively.

10. The system of claim 1, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system for performing one or more generative AI operations;
a system implementing one or more large language models (LLMs);
a system implementing one or more vision language models (VLMs);
a system implementing one or more multi-modal language models;
a system for generating synthetic data;
a system incorporating one or more virtual machines (VMs);
a system implemented at least partially in a data center; or
a system implemented at least partially using cloud computing resources.

11. A system comprising:
memory to store a test image for testing a computing system, the test image including a plurality of control packets sequentially ordered for execution in a linked list;
a register bank including one or more registers, the register bank to:
store a first test configuration that corresponds to a first test of the computing system and that corresponds to a first set of control packets of the plurality of control packets, the first test configuration indicating execution of the first set of control packets in a first execution order that differs from the sequential ordering of the first set of control packets in the linked list; and
a hardware controller communicatively coupled to the memory and the register bank and to direct execution of the first test based at least on the test image and the first test configuration.

12. The system of claim 11, wherein:
the register bank is further to:
store a second test configuration that corresponds to a second test of the computing system and that corresponds to a second set of control packets of the plurality of control packets, the second test configuration indicting execution of the second set of control packets in a second execution order that differs from the sequential ordering of the second set of control packets in the linked list; and
the hardware controller is further to direct execution of the second test based at least on the test image and the second test configuration.

13. The system of claim 11, wherein the first test corresponds to:
only a subset of the plurality of control packets; or
all of the control packets of the plurality of control packets.

14. The system of claim 11, wherein:
the first set of control packets includes all of the control packets executed during the first test; or
the first set of control packets is a subset of the control packets executed during the first test.

15. The system of claim 11, wherein execution of the first test includes the hardware controller directing execution of one or more control packets of the plurality of control packets based at least on the linked list in response to the first set of control packets not including the one or more control packets.

16. The system of claim 11, wherein:
a register of the register bank includes a first field and a second field;
the first field includes a first entry of the first test configuration that indicates a first control packet of the first set of control packets;
the second field includes a second entry of the first test configuration that indicates a second control packet of the first set of control packets; and
execution of the first test includes the hardware controller directing that the second control packet be executed immediately after execution of the first control packet based at least on the first entry and the second entry.

17. A method comprising:
accessing a test image that is for testing a computing system, the test image indicating a default execution order for a plurality of control packets while testing the computing system;
accessing a test configuration that corresponds to a test of the computing system and that corresponds to a set of control packets of the plurality of control packets, the test configuration indicating execution of the set of control packets in an execution order that differs from the default execution order; and
performing the test of the computing system based at least on the test image and the test configuration.

18. The method of claim 17, wherein the default execution order is based at least on a sequential ordering of the plurality of control packets as indicated by a linked list included in the test image.

19. The method of claim 17, wherein the test configuration is accessed from a register bank that includes one or more registers and that is loaded with the test configuration.

20. The method of claim 19, wherein the test image is accessed from a memory that is loaded with the test image and that is separate from the register bank.
